(19) United States
(12) Patent Application Publication
(10) Pub. No.: US 2011/0040427 A1
(43) Pub. Date: Feb. 17, 2011

(54) Hybrid mobile robot

(76) Inventor: Pinhas Ben-Tzvi, Kensington, MD (US)

Correspondence Address: Pinhas Ben-Tzvi, 1 Simms Court, Kensington, MD, 20895, US

(21) Appl. No.: 12/925,145

(22) Filed: Oct. 14, 2010

Related U.S. Application Data
(63) Continuation-in-part of application No. 11/980,782, filed on Oct. 31, 2007.

(51) Int. Cl. B25J 5/00; G05D 1/00; B25J 15/08

(52) U.S. Cl. 701/2; 701/23; 294/86.4

(57) ABSTRACT

An autonomous hybrid mobile robot includes a base link and a second link. The base link has a drive system and is adapted to function as a traction device and a turret. The second link is attached to the base link at a first joint. The second link has a drive system and is adapted to function as a traction device and to be deployed for manipulation. One of the links houses a retractable navigational system. In another embodiment an invertible robot includes at least one base link and a second link. In another embodiment a mobile robot includes a chassis and a track drive pulley system including a tension and suspension mechanism. In another embodiment a mobile robot includes a wireless communication system.

### CROSS REFERENCE TO RELATED PATENT APPLICATION

This patent application is a continuation-in-part of U.S. patent application Ser. No. 11/980,782 filed on Oct. 31, 2007 titled HYBRID MOBILE ROBOT which is incorporated herein by reference in its entirety.

This work was funded in part by the Defence Advanced Research Projects Agency (DARPA), Contract #HR0011-09-1-0049. The U.S. Government may have certain rights in this invention.

### FIELD OF THE INVENTION

This invention relates to mobile robots and in particular mobile robots that can be inverted and mobile robots that have an interchangeable configuration between locomotion and manipulation.

### BACKGROUND OF THE INVENTION

In the aftermath of Sep. 11, 2001, mobile robots have been used for USAR (Urban Search and Rescue) activities such as searching for victims, searching paths through the rubble that would be quicker than to excavate, structural inspection and detection of hazardous materials. Among the few mobile robots that were used such as the Inuktun's Micro-Tracs™ and VGTV™ and Foster-Miller's Solem™ and Talon™, the capability was very limited in terms of locomotion and mobility. The capabilities are further limited if one considers any requirements of manipulation with an arm mounted on the mobile robot, and because of these limitations in many instances the robotic arm was not used at all. Some of the most serious problems with the robots were the robot flipping over or getting blocked by rubbles into a position from where it could not be righted or moved at all. None of the robots used on the rubble pile searches were successfully inverted after flipping over. These are only some of the several outstanding problems among the many challenges that are still encountered in the field of small Mobile Robots for Unmanned Ground Vehicle (UGV) operations for rough terrain applications.

Increasingly, mobile robotic platforms are being proposed for use in rough terrain and high-risk missions for law enforcement and military applications (e.g., Iraq for IEDs—Improvised Explosive Devices), hazardous site clean-ups, and planetary explorations (e.g., Mars Rover). These missions require mobile robots to perform difficult locomotion and dexterous manipulation, tasks. During the execution of such operations loss of wheel traction, leading to entrapment, and loss of stability, leading to flip-over, may occur. These events often result in total mission failure.

Various robot designs with actively controlled traction, sometimes called “articulated tracks”, were found to somewhat improve rough-terrain mobility, but with limited capability to reposition the mobile robot center of gravity (COG). The repositioning of COG allows a certain degree of control over the robot stability. Efforts are continuously made in designing robots that allow a wider control over COG location providing greater stability over rough terrains. This is achieved by designing robots with displacing mechanisms and actively articulated suspensions that allow for wider repositioning of the COG in real-time. However, the implementations of such solutions most often result in complex and cumbersome designs that significantly reduce robot's operational reliability, and also increase its cost.

There are numerous designs of mobile robots such as PackBot™, Remotec-Andros™ robots, Wheelbarrow MK8™, AZIMUT™, LMA™, Matilda™, MURV-100™, Helios-II™, Variable configuration VCTV™, Ratler™, MR-1™, MR-5™ and MR-7™, NUGV™, and Talon™ by Foster Miller. They are mainly based on wheel mechanisms, track mechanisms and the combination of both. As well, some legged robots have been suggested for rough terrain use. However, all of these robots have certain limitations. Specifically they have difficulty getting out of certain situations such as if they become inverted.

A review of several leading existing mobile robot designs has indicated that it would be advantageous to provide a mobile robot wherein each kinematic link has multiple functions. Further it would be advantageous to provide a mobile robot that is invertible. Similarly it would be advantageous to provide an invertible mobile robot with an arm integrated into the platform. Still further, it would be advantageous to provide a mobile robot that has a tension and suspension system. One aim is to increase the robot's functionality while significantly reducing its complexity and hence drastically reducing its cost.

A review of several leading existing mobile robot designs has also indicated that it would be advantageous to provide a mobile robot wherein obstacle traversal, avoidance and object manipulation are automated with minimal or no operator input. Autonomy would be advantageous and desirable for robotic applications such as search and rescue missions or military and reconnaissance operations. Furthermore it would be advantageous and desirable for robotic end effectors to have high-payload and higher dexterity in operations like movement of explosives, explosive ordinance disposal, disarming improvised explosives. Furthermore general robotic systems in use have problems with degrees of freedom of the end effectors due to heavy pneumatic equipment or the necessity of wires. One of the aims of this invention is to increase the payload capability and the maneuverability of the end effector.

With respect to robotic end effectors, many designs have been proposed in the past using different actuation mechanisms. Specifically, actuators that can provide multiple torque outputs from a single power source have been favored over more traditional counterparts such as electrical motors. The reason is because these actuators allow the implementation of multiple degrees of freedom replicating the dexterity level of a human hand. Commonly, pneumatic and hydraulic actuators that have led the technology for these applications and systems with over 20 degrees of freedom such as the Shadow hand have been developed. However, despite the high level of dexterity that pneumatically and hydraulically actuated robotic hands can achieve, their implementation on mobile robotic platforms faces practicality challenges, often associated with the low-payload capabilities, the size of the air pump and compressor, the size of the hand itself or even the noise generated by the compressor fan and expanding air.

Generally speaking, mobile robotic applications favor high-payload capabilities at the end effector level over high levels of dexterity. This is dictated by the environment in which mobile robots normally operate, and the tasks they are often assigned (movement of munitions, explosive ordnance disposal, disarming improvised explosive devices). These tasks in most cases do not require surgical precision capabilities, but almost always require high payload capabilities with reasonable maneuverability levels. One of the aims of this invention is to increase the payload capability and the maneuverability of the end effector.

### SUMMARY OF THE INVENTION

A hybrid mobile robot includes a base link and a second link. The base link has a drive system and is adapted to function as a traction device and a turret. The second link is attached to the base link at a first joint. The second link has a drive system and is adapted to function as a traction device and to be deployed for manipulation.

In another aspect of the present invention an invertible mobile robot includes at least one base link and a second link. Each base link has a drive system and the base links define an upper and a lower plane. The second link is attached to at least one base link. The second link has a drive system. The second link has a stowed position and an upper and lower plane and in the stowed position the second link upper and lower plane is within the upper and lower plane of the at least one base link.

In a further aspect of the invention a mobile robot includes a chassis and pair of track drives pulley systems, one on each side of the chassis. Each track drive pulley system has a front and back pulley, a track, and a plurality of top and bottom spaced apart planetary supporting pulleys. Each pulley has a tension and suspension mechanism.

In a further aspect of the invention a mobile robot includes a base, a second link, an end link and a central control system. The base has a base drive system. The second link is attached to the base link at a first joint and the second link has a second link drive system. The end link is attached to the second link at a second joint and the end link has an end link drive system. The central control system is operably connected to the base drive system, operably connected to the second link drive system and operably connected via wireless communication to the end link.

In a further aspect of the invention, a stand-alone replaceable end effector includes a self contained module and a plurality of wireless communication modules. The self contained module houses the mechanical and electrical hardware. The plurality of wireless communication modules are housed in the self contained module for wireless communication with the main robot processing unit, other links and operator's unit. The self-contained module is attached to the mobile robot end link via a plurality of rotational pivots.

In a further aspect of the invention, a self-contained robotic end effector with at least three degrees of freedom and at least three fingers is implemented on the arm. The end effector can rotate around itself in a continuous fashion allowing it to fold inside the arm during the locomotion mode and unfold outside the arm during the manipulation mode from either side. An additional degree of freedom provides endless rotation around the wrist joint, and a third degree of freedom enables the opening and closing aspect of the fingers. Wireless communication between the fingers and the end effector processing unit enables the endless rotation around the wrist by eliminating the need for any wire connections that limit the range of rotation.

In a further aspect of the invention, a sensor mechanism comprising a stereo camera system and a LIDAR (Light Detection and Ranging) scanning mechanism are implemented on the end link or any of the left and right base links. The mechanism is equipped with two rotational degrees of freedom: One actuation rotates the mechanism outside the link in order to perform the scanning and visual perception operations. This can be achieved by deploying the mechanism from either side of the link depending upon the robot configuration. Another degree of freedom is strictly limited to the LIDAR and enables its rotation in a vertical plane, therefore extrapolating the 2-D horizontal scanning ability of the LIDAR to encompass visual perception into the 3-D domain. Visual data is augmented by inertial data provided by inertial measurement units (IMU), a GPS unit and absolute encoders adapted to all joints of the robot.

In a further aspect of the invention, a mobile robot includes a PALRF (Pitch Actuated Laser Rage Finder) sensor mechanism mounted on the link housing the gripper or any of the left and right base links, which provides accurate feedback control system of the gripper location and ability to obtain a 3D image of the environment from multiple locations resulting in reduced occlusion problems.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 shows three perspective schematic views of the hybrid mobile robot of the present invention wherein a) shows the closed or stowed position; b) shows an open configuration; and c) shows an exploded view in an open configuration;

FIG. 2 shows four perspective schematic views of the hybrid mobile robot of the present invention showing the hybrid mobile robot configured for mobility purposes wherein a) shows a partially open configuration and showing the location of a camera; b) shows a second link configured to overcome an obstacle; c) shows the second link configured so that the camera can view another location; and d) shows the second and third links configured to overcome an obstacle;

FIG. 3 shows three perspective schematic views of the hybrid mobile robot of the present invention configured for enhanced traction wherein a) shows the second link configured to be engaged with the ground; b) shows the second and third links configured to be engaged with the ground; and c) shows the second and third links configured to move over irregular terrain;

FIG. 4 shows three perspective schematic views of the hybrid mobile robot of the present invention configured for manipulation wherein a) shows the second and third links configured for manipulation; b) shows the second link configured as a platform and the third link for manipulation; and c) shows the second link configured as a platform on irregular terrain and the third link for manipulation;

FIG. 5 is a perspective view of the hybrid mobile robot of the present invention showing a flat or open configuration;

FIG. 6 is a perspective view of the hybrid mobile robot of the present invention in the stowed or closed position;

FIG. 7 is a top view of the robot of the present invention in the stowed position;

FIG. 8 is a top view of the hybrid mobile robot of the present invention in the open configuration;

FIG. 9 is a side view of the hybrid mobile robot of the present invention in the open configuration;

FIG. 10 is a perspective view of the base link track of the hybrid mobile robot of the present invention and showing the pulley arrangement;

FIG. 11 is a side view of the base link track of the hybrid mobile robot of the present invention showing the general pulley arrangement and the track tension and suspension mechanism;

FIG. 12 is an exploded view of the base link track of the hybrid mobile robot of the present invention similar to that shown in FIG. 11;

FIG. 13 is an enlarged front view of the spring housing assembly for the base link track of the hybrid mobile robot of the present invention;

FIG. 14 is an enlarged perspective view of the spring housing shown in FIG. 13;

FIG. 15 is an enlarged perspective view of the drive mechanism for the base link track of the hybrid mobile robot of the present invention;

FIG. 16 is a left perspective view of the assembly and drive mechanism of the second and third link of the hybrid mobile robot of the present invention;

FIG. 17 is an enlarged left perspective view of the drive mechanism shown in FIG. 16;

FIG. 18 is a right perspective external view of the assembly and drive mechanism of the second and third link of the hybrid mobile robot of the present invention;

FIG. 19 is an enlarged right perspective view of the first joint of the drive mechanism shown in FIG. 18;

FIG. 20 is a right perspective internal view of the assembly and drive mechanism of the second and third link of the hybrid mobile robot of the present invention;

FIG. 21 is an enlarged right perspective view of the second joint of the drive mechanism shown in FIGS. 18 and 20;

FIG. 22 is a schematic representation of an embodiment of the wireless communication layout for use with the hybrid mobile robot of the present invention;

FIG. 23 is a schematic representation of an embodiment of the hardware architecture for use with the hybrid mobile robot of the present invention wherein a) shows the right base link track including a central wireless module; b) shows the left base link track and c) shows the gripper mechanism;

FIG. 24 is a schematic layout of the sensors and cameras for the hybrid mobile robot shown in FIG. 23;

FIG. 25 shows three possible wireless modules used with the hybrid mobile robot of the present invention;

FIG. 26 shows four perspective schematic views of an alternate embodiment of the hybrid mobile robot of the present invention having a wheel drive system wherein a) shows a partially open configuration b) shows the second link configured as a platform for enhanced manoeuvrability and the third link for manipulation; c) shows the second link configured as a platform for enhanced traction and the third link for manipulation and d) shows the closed or stowed configuration;

FIG. 27 shows four perspective schematic views and a top view of an alternate embodiment of the hybrid mobile robot of the present invention having a right and left base link position adjacent to each other with a second link on one side thereof and a third link nested in the second link, wherein a), b) and c) show the open configurations, d) shows the closed or stowed configuration, and (e) shows the top view of the closed or stowed configuration;

FIG. 28 shows four perspective schematic views of a further alternate hybrid mobile robot of the present invention similar to that shown in FIG. 27 except that the third link is adjacent to the second link on the opposed side of the second link, wherein a), b) and c) show the open configurations, and d) shows the closed or stowed configuration;

FIG. 29 shows three perspective schematic views of a further alternate hybrid mobile robot of the present invention similar to those shown in FIGS. 27 and 28 but having the second link on one side of the right and left base links and the third link on the other side of the right and left base links, wherein (a) shows the closed or stowed position and b) and c) show the open configurations;

FIG. 30 shows three perspective schematic views and a top view of another alternate embodiment of the hybrid mobile robot of the present invention similar to that shown in FIG. 4, but having the left and right base links joined at each end thereof wherein a) b) and c) show open configurations and (d) is the top view of the closed configuration;

FIG. 31 is a perspective view of a hybrid robot of the present invention showing cameras and other accessories, an end effecter, and passive wheels on the third joint;

FIG. 32 shows five schematic views of the hybrid mobile robot of the present invention showing alternative configurations for manipulation wherein (a), (b) and (d) are similar to the configurations shown in FIGS. 4(a), (b) and (c), respectively; and FIG. 32(c) shows a configuration where the second and third links are deployed towards the base link tracks; and FIG. 32(e) shows a configuration where the third link is deployed for manipulation purpose and the second link remains nested between the base links;

FIG. 33 is a perspective view of the hybrid mobile robot of the present invention showing an open configuration with the end effector deployed outside the end link with an open-fingers configuration;

FIG. 34 shows a perspective view of the hybrid mobile robot with a closed configuration wherein the end link is folded inside the second link and the second link is folded inside the base links;

FIG. 35 shows a top view of the assembly with the tracks and covers hidden and wherein detail [a] shows a close-up view of the tracks transmission including the pulleys and the gearbox, and detail [b] shows a close-up view of the front transmission including gearbox and chain assembly to drive the second and end links;

FIG. 36 shows a front and side view of the hybrid mobile robot with the navigational system deployed wherein detail [a] shows a close-up view of the navigational system with the LIDAR sensor and the stereo camera connected together to a 2-DOF servo-actuated mechanism. The navigational mechanism is capable of deploying from either side of the end link, as shown in side view of FIG. 36, depending upon the orientation of the robot. The additional navigational mechanism shown in dashed lines is meant to illustrate this feature;

FIG. 37 shows a block diagram of the wireless protocol established between the fingers of the end effector, the end effector, the end link, and the left and right base links, as well as with the operator's control unit (OCU);

FIG. 38 shows a perspective close-up view of the end link assembly with the end effector assembly deployed outside the end link.

FIG. 39 shows a perspective view of the end effector in the closed configuration of the fingers;

FIG. 40 shows perspective views and exploded views of the end effector with [a] showing the opened configuration of the fingers and [b] showing the exploded view of the end effector;

FIG. 41 shows an exploded view of the end effector with all hardware including power source, camera, motor controllers, electronic boards and wireless modules;

FIG. 42 shows a kinematic representation of the end effector with the 3-DOF's highlighted and the location of the fingertip characterized by two planar coordinates (Xₜᵢₚ and Yₜᵢₚ);

FIG. 43 shows a mobile robot wherein the second link has the function of acting as a second link of an arm, and the second link is pivotally attached to the spaced apart left and right base links with two degrees of freedom 81 and 86. Therefore, the manipulation arm (consisting of the second link, end link and end effector) is attached to the chassis of the robot (left and right base links) by way of a turret joint (DOF θ6);

FIG. 44 shows an illustration of the hybrid mobile robot crossing a ditch using its links and tracks. This can also be achieved autonomously where the navigational system analyzes the dimensions of the ditches and actuates the links in the illustrated concession in order to cross the ditch;

FIG. 45 shows an illustration of the hybrid mobile robot overcoming an obstacle. The process can also be achieved autonomously wherein the navigational system can analyze the height of the obstacle and the distance to it and actuate the links in the illustrated concession in order to overcome the obstacle;

FIG. 46 shows an illustration of the hybrid mobile robot descending an obstacle. The process can also be achieved autonomously wherein the robot uses the navigation system to detect the depth of the descent before executing the steps in the concession shown. The field of view of the navigational system can be expanded using the manipulator arm;

FIG. 47 shows an illustration of the hybrid mobile robot overcoming a cylindrical obstacle. The process can also be achieved autonomously wherein the robot uses the navigational system to assess the dimensions of the cylinder and execute the steps in the concession shown;

FIG. 48 shows an illustration of the hybrid mobile robot climbing stairs. The process can also be achieved autonomously wherein the robot uses the navigational system to detect the edge of the first steps and assess its height and the stairs slope before actuating the links in the illustrated concession;

FIG. 49 shows an illustration of the hybrid mobile robot descending stairs. The process can also be achieved autonomously wherein the robot uses the navigation system to detect the depth of the descent before executing the steps in the concession shown. The field of view of the navigational system can be expanded using the manipulator arm;

FIG. 50 shows an illustration of the hybrid mobile robot carrying a heavy object. Because of the shift in the centre of mass of the robot due to the eccentric load, the robot structure reconfigures itself inherently to display a configuration with the most stable anchor point before lifting the object;

FIG. 51 shows an illustration of the hybrid mobile robot overcoming an obstacle using the second link supporting the base links from the front and then the third link supporting the base links from the back. The process can also be achieved autonomously wherein the navigational system can analyze the height of the obstacle before actuating the arm links in the illustrated concession;

FIG. 52 shows an illustration of the hybrid mobile robot climbing an obstacle while concurrently holding an object using the manipulator arm end link and end effector while the second link is used to support the base links with the aid of the wheel located in the second joint while climbing the obstacle;

FIG. 53 shows an illustration of the hybrid mobile robot descending an obstacle while concurrently holding an object using the manipulator arm end link and end effector while the second link is used to support the base links with the aid of the wheel located in the second joint while descending the obstacle; and

FIG. 54 shows an illustration of the hybrid mobile robot lifting an object from underneath using the second and third links.

### DETAILED DESCRIPTION OF THE INVENTION

The present invention introduces a new paradigm of mobile robot design for locomotion and manipulation purposes that was realized based on identifying and quantifying the existing gap between the traditional structures of typical mobile robots and their range of applications. Typically, a mobile robot's structure consist of a mobile platform that is propelled with the aid of a pair of tracks, wheels or legs, and a manipulator arm attached on top of the mobile platform to provide the required manipulation capability. However, the presence of an arm limits the mobility. On the other hand, there are several designs of mobile robots with the ability to return itself when flipped-over, but this is not possible if the robot is equipped with a manipulator arm. This gap is bridged in the approach herein by providing a new paradigm of mobile robot design that provides locomotion and manipulation capabilities simultaneously and interchangeably. The approach is also a new way of robot-surroundings interaction as it increases the mobile robot's functionality while reducing its complexity and hence reducing its cost and increasing its reliability.

The new design paradigm is based on hybridization of the mobile platform and the manipulator arm as one entity for robot locomotion as well as manipulation. The new paradigm is that the platform and the manipulator are interchangeable in their roles in the sense that both can support locomotion and manipulation in several configuration modes. Such a robot can adapt very well to various ground conditions to achieve greater performance as a prospective product for a variety of missions for military, police and planetary exploration applications.

### Description of the Design Paradigm

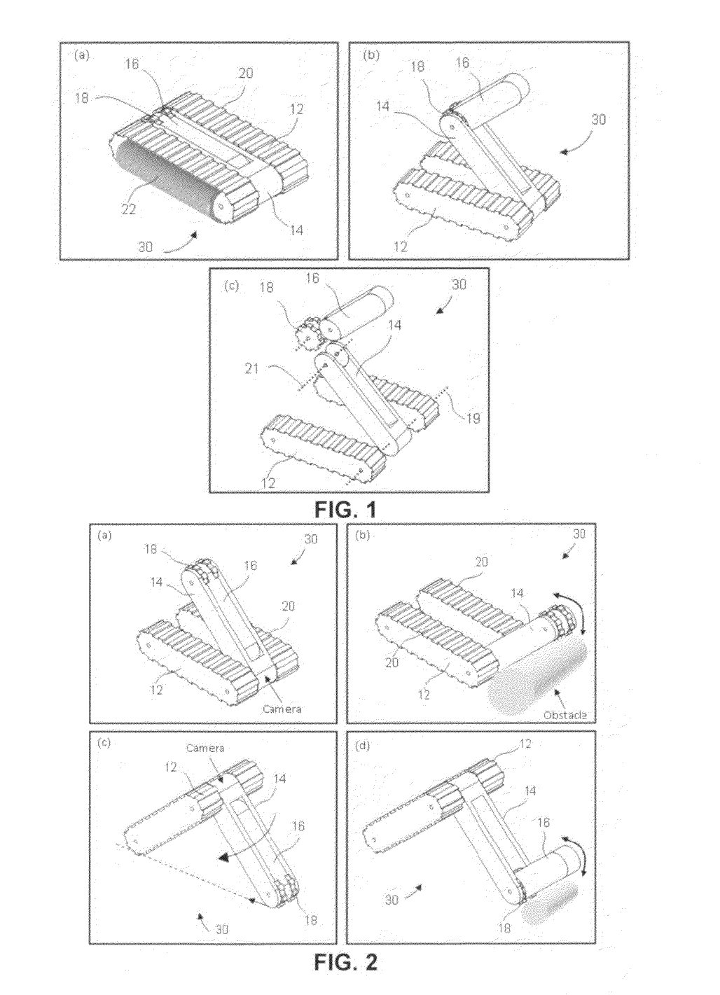

FIG. 1 of the drawings depicts the mobile robot 30 of the present invention. If the platform is inverted due to flip-over, the symmetric nature of the design (FIG. 1(a)) allows the platform to continue to the destination from its new position with no need of self-righting. Also it is able to deploy/stow the manipulator arm from either side. Preferably rounded and pliable side covers 22 are utilized to prevent immobilization when the robot 30 flips over on either side as shown in FIG. 1(a).

The robot 30 includes two base links 12, link 14, link 16 and two wheel tracks 18. Link 14 is connected between the two base links 12 via a first joint 19 (FIGS. 1(b) and (c)). The two base links 12 have tracks 20 attached thereto. Two wheel tracks 18 are inserted between links 14 and 16 and connected via a second joint 21 (FIGS. 1(b) and (c)). The wheel tracks 18 are used. to support links 14 and 16 when used as part of the platform while touching the ground. The wheel tracks 18 may be used passively or actively for added mobility. Both links 14 and 16 are revolute joints and are able to provide continuous 360 degree rotation. The robot's structure allows it to be scalable and can be customized according to various application needs.

### Modes of Operation

The links 12, 14, 16 can be used in three modes:
1) All links used for locomotion to provide desired levels of maneuverability and traction;
2) All links used for manipulation to provide added level of manipulability. The pair of base links 12 can provide motion equivalent to a turret joint of the manipulator arm;
3) Combination of modes 1 and 2. While some links are used for locomotion, the rest could be used for manipulation at the same time, thus the hybrid nature of the design paradigm.

All three modes of operation are illustrated in FIGS. 2, 3 and 4. In the proposed design the motors 24 and 88 (best seen in FIG. 8) used to drive the platform are also used for the manipulator arm as the platform itself is the manipulator arm and vice versa. In other words, the platform can be used for mobility while at the same time it can be used as a manipulator arm to perform various tasks.

### Manoeuvrability

FIG. 2 shows the use of link 14 to support the platform for enhanced mobility purposes. Link 14 can also be used for climbing purposes. Link 14 helps to prevent the robot 30 from being immobilized due to high-centering, enables the robot 30 to climb taller objects (FIG. 2(b)), and can help propel the robot 30 forward through continuous rotation. Link 14 is also used to support the entire platform while moving in a tripod configuration (FIG. 2(c)). This can be achieved by maintaining a fixed angle (90.degree. for instance) between link 14 and the base link 12 while the tracks 20 (shown more clearly in FIG. 10) are propelling the entire platform. Configurations (a) and (c) in FIG. 2 show two different possible configurations for camera use. Configuration (d) in FIG. 2 shows a case where link 16 is used to surmount an object while link 14 is used to support the entire platform in a tripod structure.

The posture of the tripod configuration as shown in FIG. 2(c) can be switched by placing link 14 behind the base links 12 instead of in front of them. This can be achieved by rotating link 14 in a clockwise direction (180.degree. for instance) while passing it between the base links 12. This functionality is effective when it is necessary to rapidly change the robot's 30 direction of motion in a tripod configuration.

### Traction

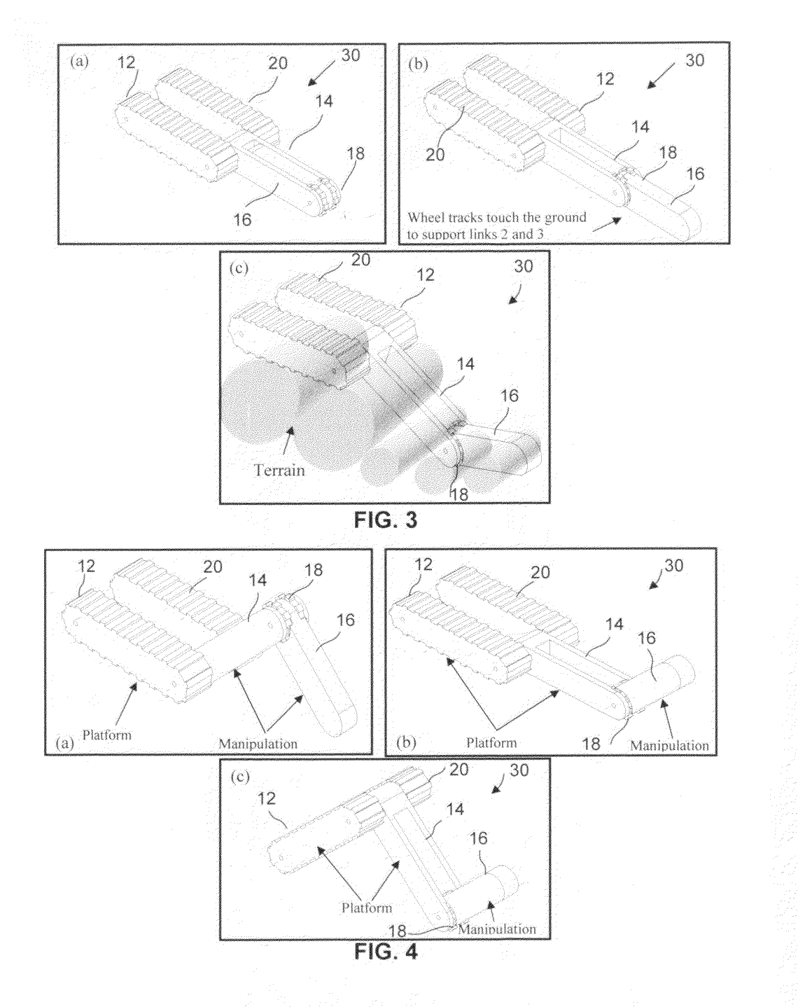

For enhanced traction, link 14, and if necessary link 16 can be lowered to the ground level as shown in FIGS. 3(a) and 3(b). At the same time, as shown in configuration (c), the articulated nature of the mobile platform allows it to be adaptable to different terrain shapes and ground conditions.

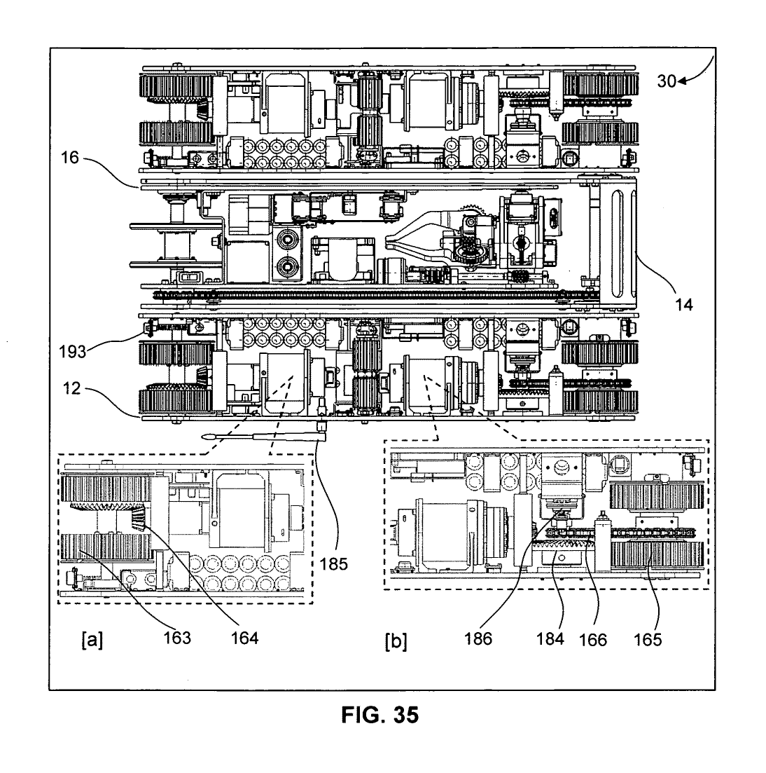

The reduced width pulley drive mechanism of the base links is depicted in FIG. 35, where the tracks of the base link 12 Left and Right are driven by a gearbox-bevel gear mechanism 164. In order to minimize the width of link 12, the driving pulleys 163 are split in half and only connected together via a central shaft extrusion. The larger diameter bevel gear of the assembly 164 is connected via screws and pins to the inside of the pulleys 163. The larger bevel meshes with a smaller bevel connected directly to the output shaft of the motor and gearbox assembly. Actuation of the motor will actuate the bevels which in turn will transmit the torque to the pulleys and therefore to the robots tracks.

### Manipulation

FIG. 4 depicts different configurations of the platform for manipulation purposes. It can be seen that while some links are used as the locomotion platform others are used simultaneously for manipulation. Configuration (c) is similar to configuration (b) in FIG. 4 in terms of manipulation capabilities; however, configuration (b) is optimal for enhanced traction since the contact area between the locomotion platform and the ground is maximized. Configuration (c) is useful for increased maneuverability since the contact area between the locomotion platform and the ground is minimized.

FIG. 35 depicts the drive mechanism of the second link 14 where the rotation of link 14 is provided through a spiral bevel gear 184 and a chain transmission 166 assemblies driven by a motor and gearbox assembly. To ensure that the driving mechanism occupies minimal space in the base links, the front pulleys 165 are split in half. Each half is free to rotate on ball bearings driven passively by the tracks actuated by pulleys 163. The sprocket of the chain transmission 166 is connected directly to the driving shaft of link 14. An absolute encoder assembly 186 is coupled to the rotating shaft of the spiral gear 184 through a miniature pulley mechanism that replicates the transmission ratio of the sprockets-chain assembly in order to monitor the absolute angular position of link 14. The drive mechanism of the third link 16 is similar to the one described for link 14 with the addition of additional sprocket-chain mechanism used to transfer the motion from the base link to the second joint to actuate the third link 16.

Referring to FIG. 32, five configurations for manipulation are shown wherein FIGS. 32(a), (b) and (d) are similar to those shown in FIGS. 4(a), (b) and (c). Two other alternative configurations are shown in FIGS. 32(c) and (e). In FIG. 32(c), the second link 14 and third or end link 16 are deployed towards the base link tracks in the opposite direction such that the robot's structure allows for greater tip-over stability in order to carry heavier loads at the end-effecter. In this configuration, the COG of link 16 is closer to the COG of links 12 in order to provide much greater tip-over stability. FIG. 32(e) shows a configuration where the third link 16 is deployed for manipulation purpose, while the second link 14 remains folded between the base links 12 to allow manipulation with enhanced (yet less) tip-over stability but in more confined spaces without the second link 14 deployed to support the entire platform.

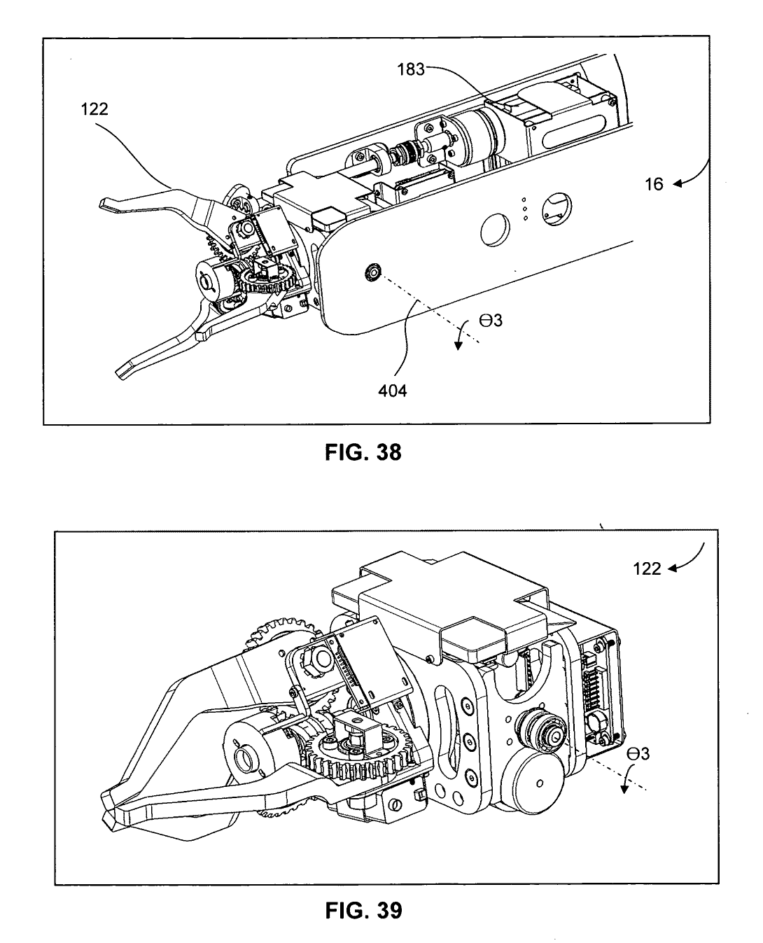

Referring to FIGS. 38, 39, 40 and 41, an end effector 122 with three or more fingers 171 is mounted at the end link 16 of the manipulator arm. This end effector is contained in a rectangular structure that communicates with the robot end link's frame through one rotational degree of freedom θ3 allowing endless rotation around the joint. The remaining degrees of freedom, essentially the rotation θ5 of the hand wrist around its centroidal axis and the rotation θ4 of the fingers around their respective pivot axes are actuated from inside the hand structure. In order to enable endless rotation of the wrist, the fingers' platform is made self-sufficient with its own power source 174 and sensors (encoders 181) and wireless communication means 182. The latter enables the transmission of the fingers positional and angular data to the robot processor via an internal wireless network. A camera 173 located inside the wrist and shielded by the fingers further transmits visual data about the gripping process to the operator's unit.

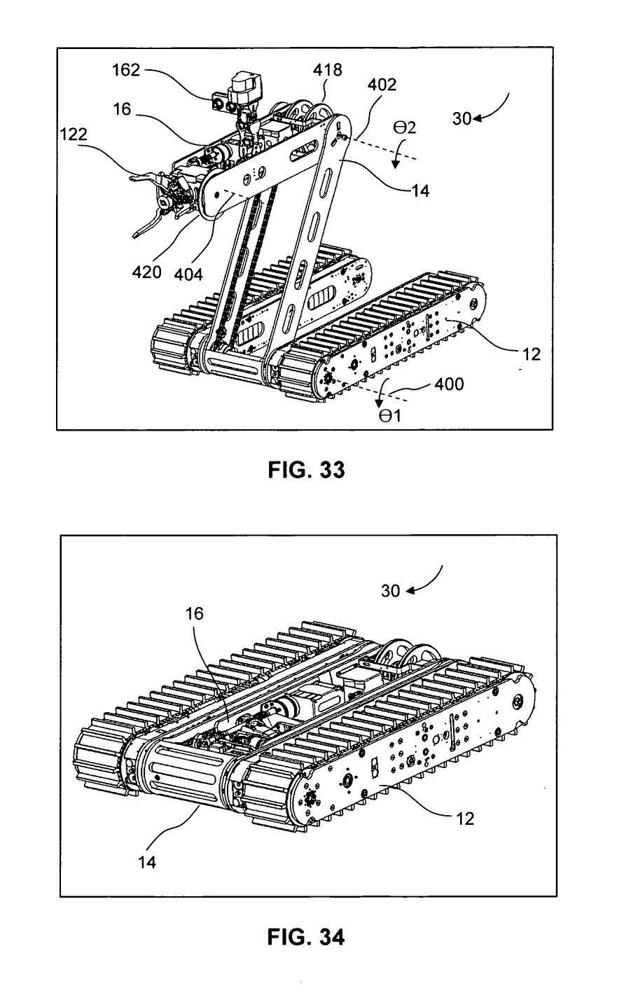

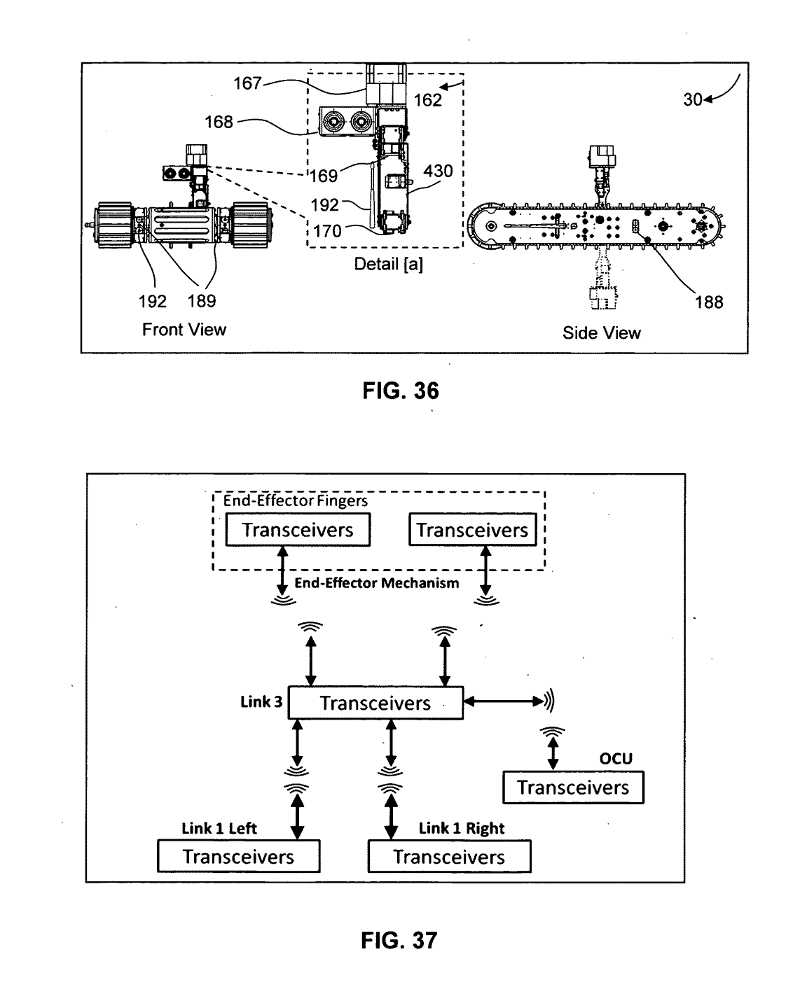

Referring to FIGS. 33 and 36, a LIDAR-Stereo camera mechanism 162 is mounted on the end link 16 of the robot. The current configuration has the stereo camera 168 and the LIDAR 167 mounted together on the same mechanism although other embodiments are possible such as the cameras being on the base link 12 and only the LIADR on the end link 16. Preferably a PC-104 computer board 183 is included in the structure in order to process the visual data captured by the cameras 168. This feature relates to prospective applications involving autonomous capabilities, such as autonomous gripping using the arm and the end effector. In another embodiment the LIDAR-Stereo camera mechanism 162 could be augmented or replaced in part or completely by a Pitch Actuated Laser Range Finder (PALRF). PALRF when mounted on the end link 16 of the manipulator arm has the advantage of accurate feedback control system for the location of the gripper. Further obtaining the 3D image of the environment from different locations will drastically reduce the occlusion problem associated with other methods. The PALRF could be replaced or augmented by other known sensor methods including but not limited to Flash Laser Detection and Ranging, Fixed laser range finders, Binocular stereovision systems, Pitch-Actuated Laser Range Finder or a combination of the above systems.

### Mechanical Design Paradigm Architecture

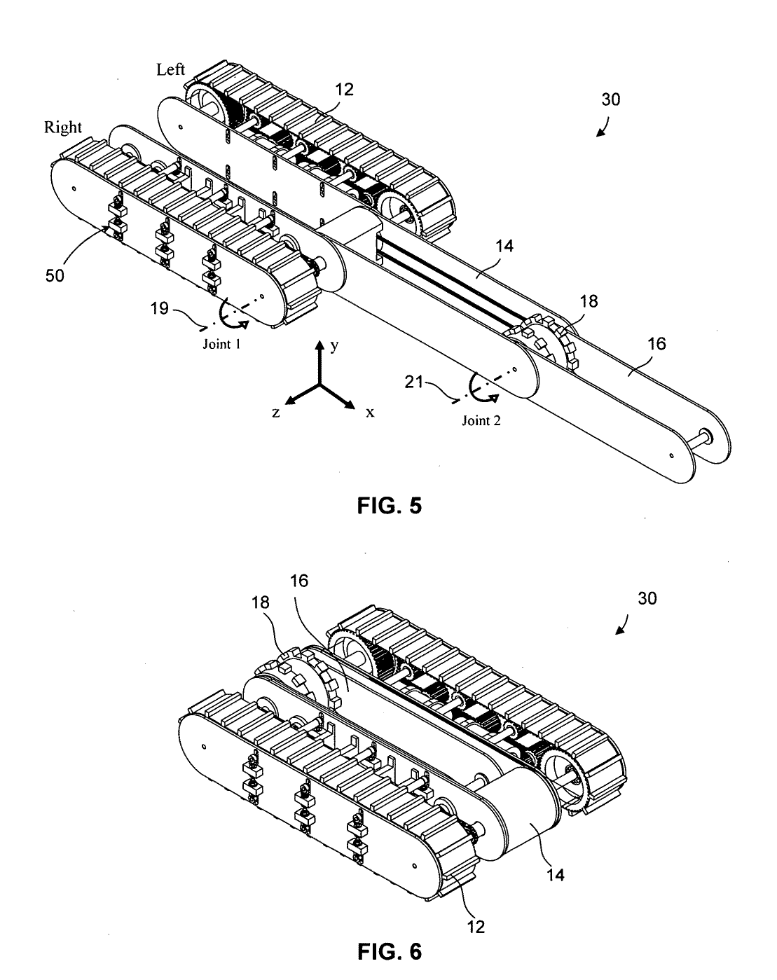

The mechanical architecture of the mobile robot shown in FIG. 5 depicts the embodiment of the conceptual design paradigm. It includes a pair of base links 12 (left and right), a second link 14, a third or end link 16, and two wheel tracks 18. Link 14 is connected between the left and right base link 12 via the first joint 19. Two wheel tracks 18 are inserted between links 14 and 16 and connected via the second joint 21. The design also includes a built-in dual-operation track tension and suspension mechanism 50 situated in each of the base link 12 and is described below. This section describes in detail the platform drive system, arm joint design and integration of the arm into the platform. It will be appreciated by those skilled in the art that wheel tracks 18 are an example of a means of traction and that other traction means could be used.

Along with the challenge and effort to realize the concept into a feasible, simple and robust design, most of the components considered in this design are off-the-shelf. The assembly views show the platform/chassis design and the different internal driving mechanisms along with description of the components used and their function.

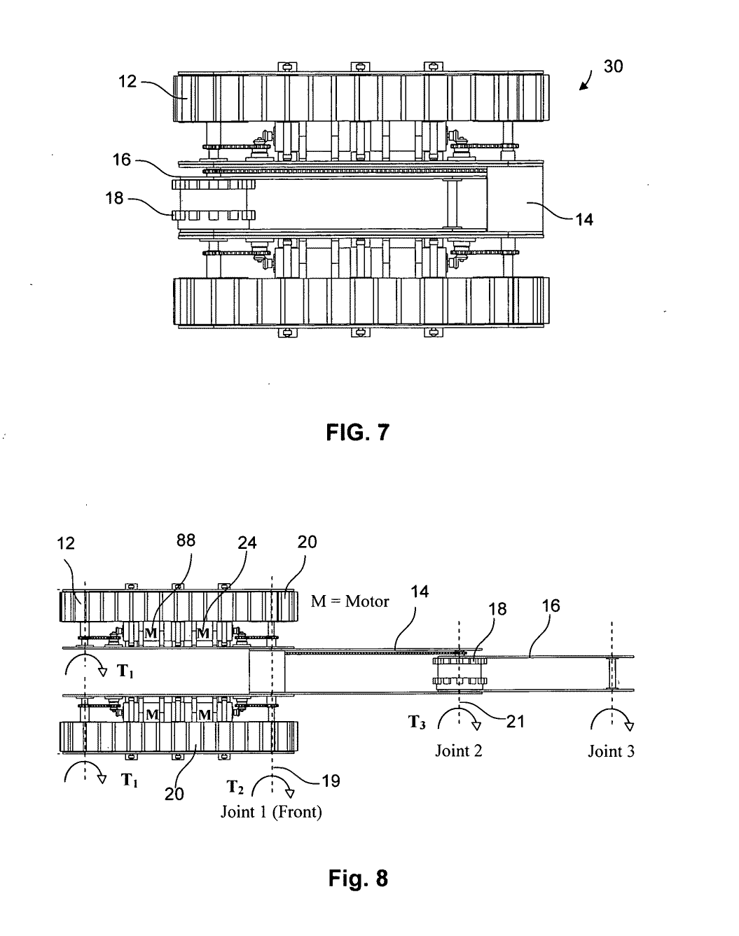

The closed configuration of the robot (FIGS. 6 and 7—all links stowed) is symmetric in all directions x, y and z. Although the design is fully symmetric, for the purpose of explanation only, the location of first joint 19 will be taken as the reference point, and it will be called the front of the robot. In the stowed or closed configuration link 16 is nested in link 14 such that no part of link 16 is above or below link 14. Similarly in the stowed or closed configuration link 14 is nested between base links 12 wherein no part of link 14 is above or below base link 12.

### Motors

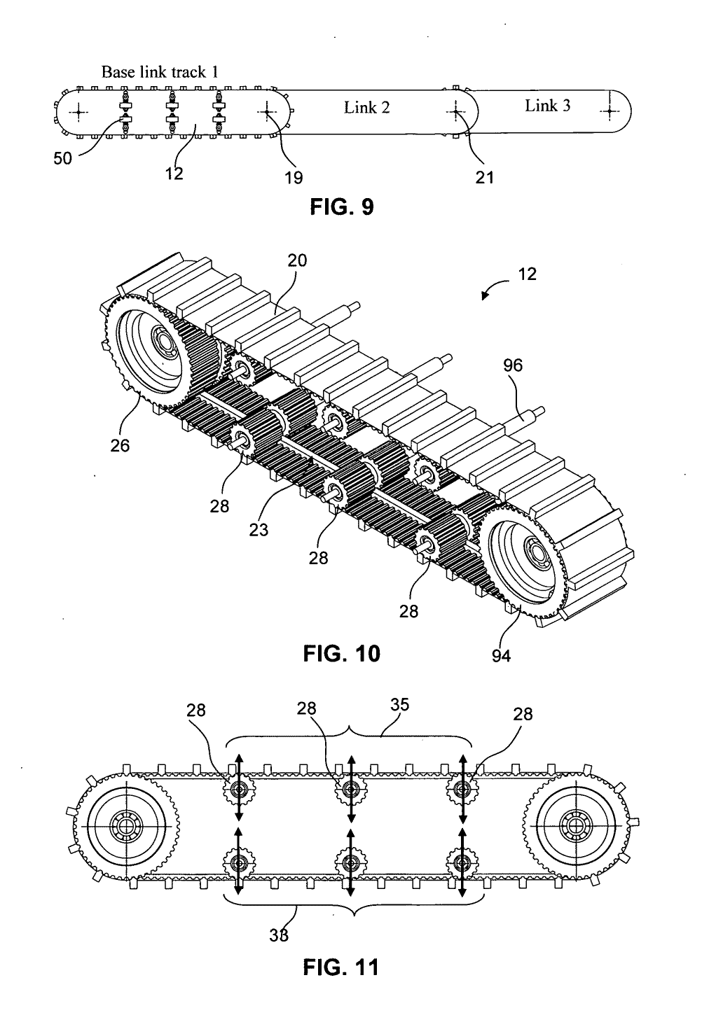

Referring to FIG. 8, excluding the end effector, the design includes four motors 24 and 88. Two motors 88 are situated at the back of each of the base link 12 and the other two motors 24 at the front. The motor 88 at the back of each base link 12 provides propulsion to the track 20 attached to that specific base link 12. Both motors 88 at the back together provide the mobile robot 30 translation and orientation in the plane of the platform. The motor 24 at the front of each base link 12 provides propulsion to one additional link. The motor 24 at the front of the right base link propels link 14 and the motor 24 at the front of the left base link 12 propels link 16 (FIGS. 8 and 9). The fact that all link motors are situated at the base provides an important feature to the design since the entire structure's COG is maintained close to the ground.

### Base Link 1—Tracks

Referring to FIGS. 10 and 11, the right and left base links 12 are each symmetric in all directions (x, y & z) and preferably identical in terms of the internal driving mechanisms although the mechanisms situated at the front of each base link 12 drives a different link.

Preferably, the width of each track 20 is 100 mm. This is wide enough to enhance support and traction over the ground. The tracks 20 used in this design may be off-the-shelf components. In the center of each track 20, there is a rib 23 that fits into a guide located at the center of the main pulleys 26 and 94 outer rim, as well as on all six planetary supporting pulleys 28 (FIG. 10). This feature prevents the track 20 from sliding off laterally, thus preventing the tracks 20 from coming off the main pulleys 26 and 94 and all six planetary supporting pulleys 28. Rib 23 may be solid as shown herein or serrated.

### Built-In Dual-Operation Track Tension and Suspension Mechanism

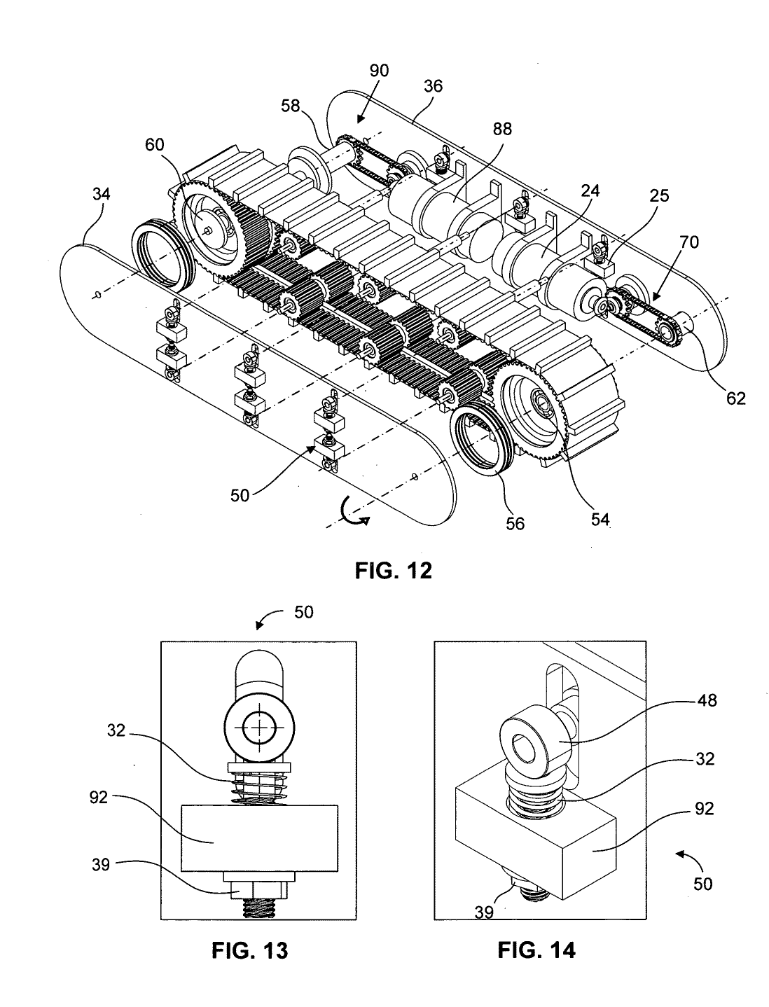

The tension and suspension mechanism 50 of the supporting planetary pulleys 28 is shown in detail in FIGS. 13 and 14. Each of the supporting pulleys 28 is mounted on a supporting bar 96 (FIG. 10) that is suspended at each end by a compression spring 32 (FIGS. 12-14). The top of each compression spring 32 is supported by a spring guide 48 while the bottom of each spring 32 is seated in a spring housing 92. The ends of each supporting bar 96 are guided through a groove in the right base link wall 34 and left base link wall 36 of the base link 12 as shown in FIG. 12. Therefore, each set of three planetary supporting pulleys 28 in the top and bottom of the left and right base link 12 is suspended by a 2×3 spring 32 array. It will be appreciated by those skilled in the art that the set of three planetary supporting pulleys 28 is by way of example only and that the number of supporting pulleys may be chosen by the user. The purpose of the supporting pulleys 28 is dual and they provide two very important functions. While the bottom three supporting pulleys 28 in each base link 12 are in contact with the ground, they act as a suspension system as shown in FIG. 11 at 33. At the same time, the upper three supporting pulleys 28 will provide a predetermined tension in the track 20 as shown in FIG. 11 at 35. This dual operation track suspension and tension system 50 accounts for the symmetric nature of the design and operation of the mobile robot 30. In other words, if the platform is inverted, the three supporting pulleys 28 that were used as suspension will act to maintain the tension in the tracks 20, while the other three pulleys 28 that were used to provide tension in the tracks 20 will act as a suspension system. The required tension in the track 20 and the suspension stroke can be preset to required values by fastening or loosening the compression nuts 39 (FIGS. 13 and 14). Another usage of the spring 32 array is to absorb energy resulting from falling or flipping, thus providing some compliance to impact forces.

### Driving Mechanisms

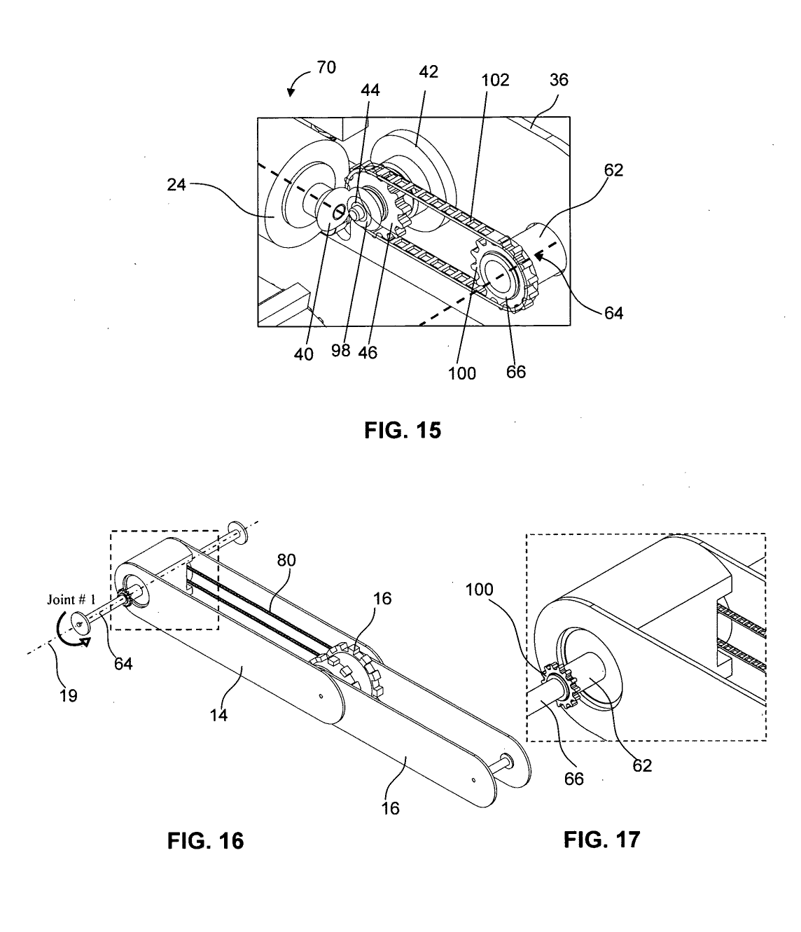

Each motor 24 and 88 is connected to a front driving gear mechanism 70 and back driving gear mechanism 90, respectively (see FIG. 12). The back driving gear mechanism 90 in the rear of each base link 12 provides propulsion to the track 20 and the front driving gear mechanism 70 in the front of the right and left base link 12 provides propulsion to links 14 and 16, respectively. A magnification of the front driving mechanism 70 is shown in FIG. 15.

Each driving mechanism includes a miter gear 40 attached to the motor 24 and 88 shaft. The corresponding miter gear 98 is attached perpendicularly to the left base link wall 36 through a stationary shaft 42 and sleeve bearing 44. One sprocket 46 is attached to the miter gear 98 while the other sprocket 100 is attached to first joint 19 driving shaft 62 and supported by the front axle 64 via sleeve bearings 66 as shown in FIGS. 16 and 17. Sprocket 100 is driven by sprocket 46 via ANSI chain 102. Depending on whether the driving gear mechanism 90 and 70 propels a pulley 26 and link 14 or 16 respectively, the only part that is different in each driving mechanism is the driving shaft (driving shaft 62 for driving link 14 and driving shafts 68 and 82 for driving link 16).

As shown in FIG. 12, the back pulley 26 is supported by a stationary axle 60 via two radial ball bearings 54 and one thrust bearing 56. The thrust bearing 56 eliminates any direct contact between the back main pulley 26 and the front main pulley 94 and the right base link wall 34 to ensure smooth and frictionless running of each main pulley 26 and 94 and to eliminate any gaps at the same time. Each of the back driving mechanisms 90 is propelling a driving shaft 58 that is connected to the back pulley 26 in a flange connection and is mounted on the back axle 60 in a concentric manner via sleeve bearing.

As shown in FIG. 15, the right front driving mechanism 70 is propelling first joint 19 driving shaft 62, which is connected to link 14 in a flange connection and is mounted on the front axle 64 in a concentric manner via sleeve bearing 66.

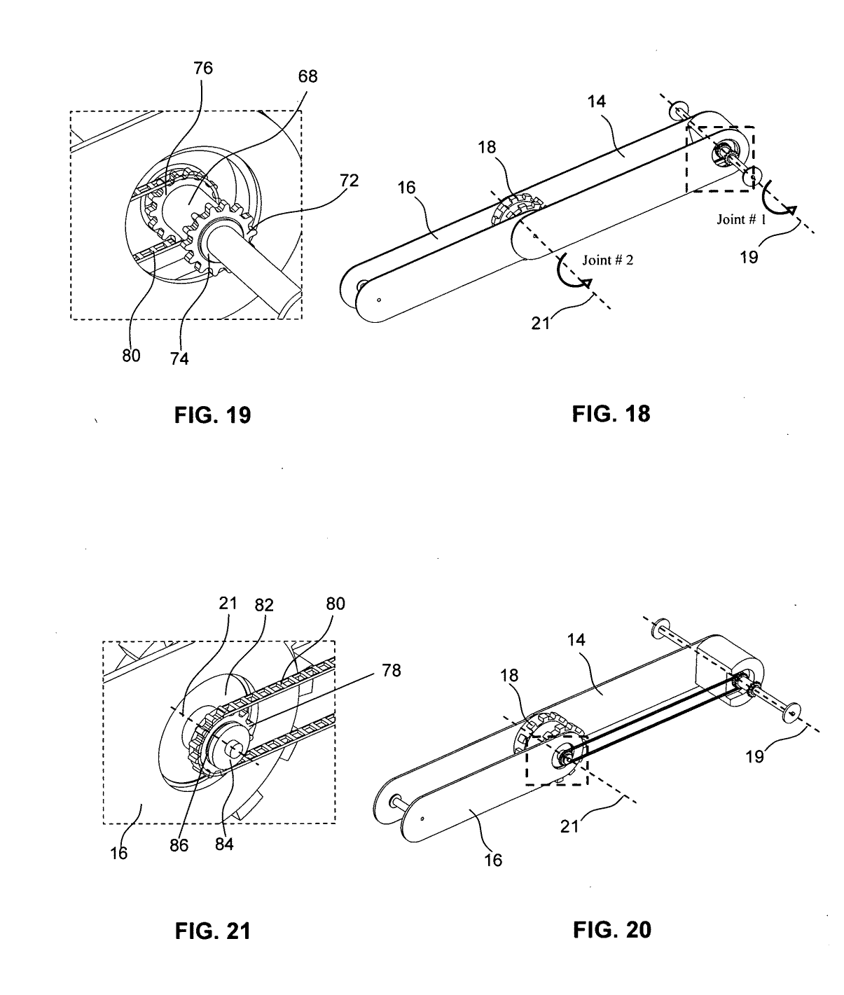

As shown in FIGS. 18 to 21, the left front driving mechanism 70 is propelling a stand alone driving shaft 68 (via sprocket 72) that is mounted on the front axle 64 in a concentric manner via sleeve bearings 74. Both ends of stand alone driving shaft 68 are attached to sprockets 72 and 76. Sprocket 76 is driving sprocket 78 through ANSI chain 80. Sprocket 78 is attached to second joint 21 driving shaft 82 that is connected to link 16 in a flange connection and is mounted on link 14 axle 84 in a concentric manner via a sleeve bearing 86.

### Communication and Electrical Hardware Architecture

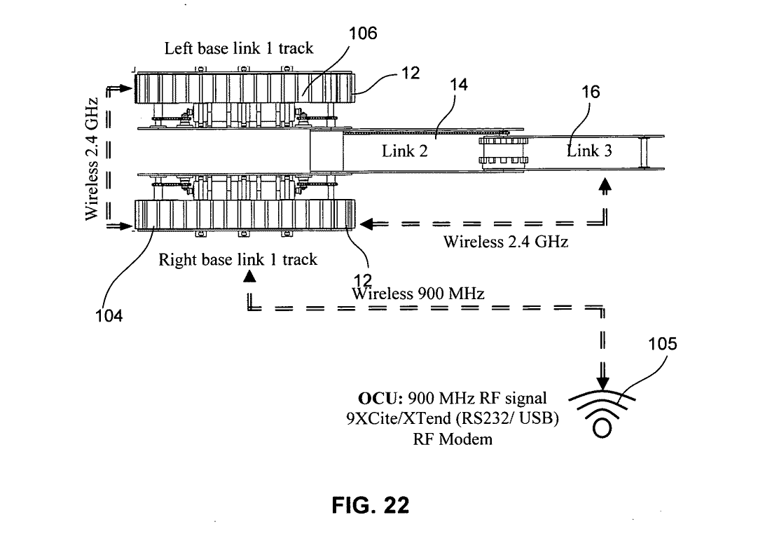

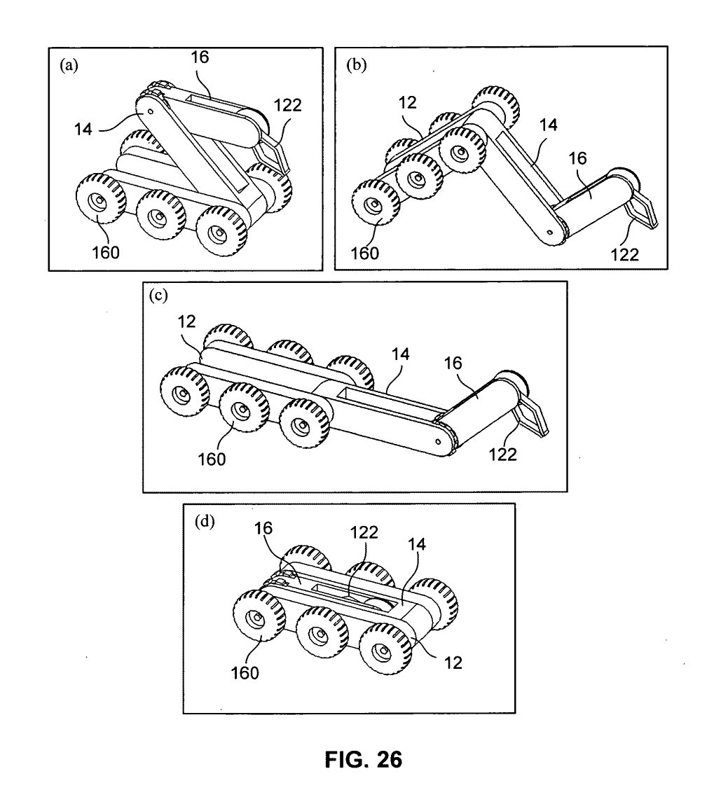

Referring to FIGS. 22-25, preferably the electrical hardware in each of the segments constituting the robot (two base link 12, second link 14 and third link 16) are not connected via wires for data communication distribution purposes. The electrical hardware is situated in three of the robot's segments—namely, two base link 12 and third link 16. The electrical hardware associated with the end effector or gripper mechanism (best seen in FIGS. 26-32) is situated in third link 16 and is not connected to any of the base link tracks via wires. Each of the segments contains individual power source (rechargeable batteries) and wireless data transceiver modules for inter-segmental wireless communication.

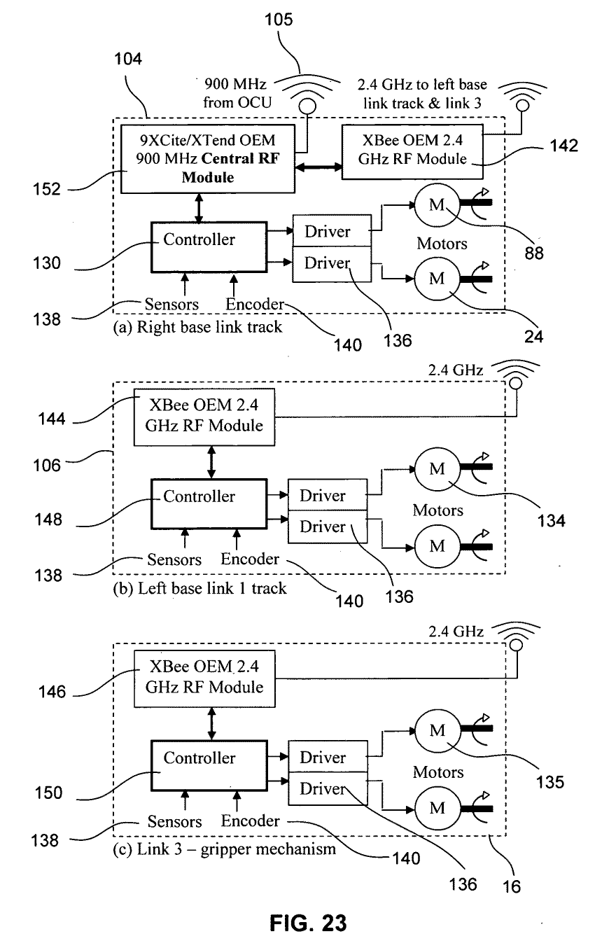

It will be appreciated by those skilled in the art that the wireless system used herein may be any type of wireless system including for example an RF (radio frequency) system or an IR (infrared) system. The specific example shown herein in FIG. 23 is an RF system and is shown by way of example only. The right base link track 104 contains a central RF module (FIG. 23(a)) for communication with a remote OCU (Operator Control Unit) 105, while each of the remaining segments contain RF module for inter-segmental on-board RF communication. This, along with independent power source in each segment, eliminates the need for physical wire, wire loops and slip ring connections between the rotating segments. This enables each of the second link 14 and the third link 16 and the gripper mechanism to provide continuous rotation about their respective joints without the use of slip rings and other mechanical means of connection that may restrict the range of motion of each link.

The central control system or control module can be located anywhere in the mobile robot. It does not have to necessarily be located in the base link. From its location anywhere in the robot, it can communicate with the other links in the robot and the remote OCU 105 in a wireless manner.

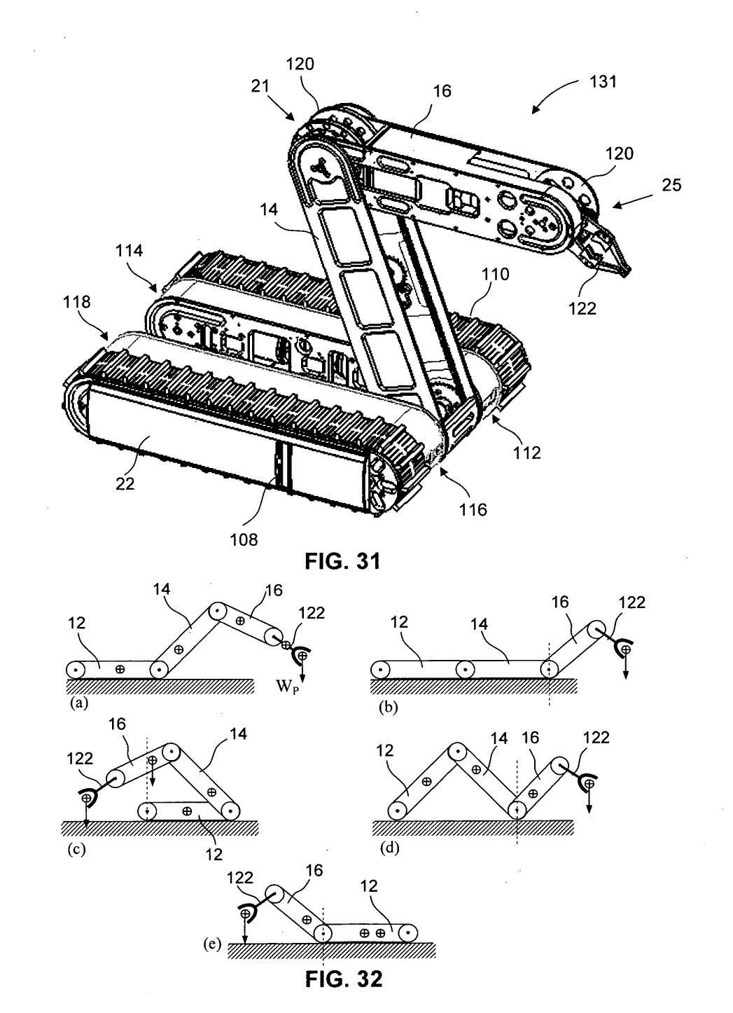

By avoiding direct communication between each of the three segments of the robot and the OCU, major problems are minimized. Specifically, there is no need to have a stand-alone vertically sticking out antenna for each of the robot's segments. Sticking out antennas are not desirable due to the robot's structural symmetry, which allows the robot to flip-over when necessary and continue to operate with no need of self-righting. Flat antennas are embedded into the side covers 22 (shown in FIG. 1 and FIG. 31) of the robot for wireless video communication and wireless data communication.

In addition, if each of the base link tracks 104, 106 are receiving data from the OCU directly, loss of data due to physical obstructions (walls, trees, buildings, etc.) between transmitter and receiver may result in inconsistent data acquisition by each base link track that may lead to de-synchronization between the track motions. To overcome this limitation all the data pertaining to all segments of the robot is received in one location in the robot and then transmitted and distributed to the other segments (the segments are separated by fixed distances from one another with no external physical obstructions), then the data received by each of the base link tracks will be virtually identical and any data loss that occurred between the OCU 105 and the robot will be consistent.

Due to the short and fixed distances between the robot's segments/links, the above mentioned problems can be solved by using a low-power on-board wireless communication between the left 106 and right 104 base link tracks and third link 16.

As shown in FIG. 23, preferably the OCU includes MaxStream 9XCite or 9XTend 900 MHz RF Modem. The data transmitted by the stand alone RF modem OCU 105 is received by a 9XCite or 9XTend OEM RF Module 152 (depending on the required range) that is situated in the right base link track 104 as shown in FIG. 23(a). The 9XCite module 152 communicates with the right controller 130 that controls the electronics in the right base link track while at the same time sends data pertaining to the other segments (left base link track 106 and third link 16) to a MaxStream XBee OEM 2.4 GHz RF Module 142 in a wire connection. The electronic controls include motors 88, 24 in the right base link track, motors 134 in the left base link track and motors 135 in the link 16 and associated drivers 136, sensors 138, encoders 140 etc. This dada is then transmitted in a wireless manner to two other XBee OEM 2.4 GHz RF Modules 144 and 146 respectively for the left base link track 106 and the other for third link 16 (FIGS. 23(b) and (c)). Modules 144 and 146 communicate with left controller 148 and third link controller 150, respectively. Left controller 148 and third link controller 150 control the electronics (motors 134 and associated drivers 136, sensors 138, encoders 140 etc.) in the left base link track and gripper mechanism, respectively. The back motor 88 and front motor 24 indicated in FIG. 8 are shown in FIG. 23(a). Motor 24 in the front of the right base link track 104 drives link 14 and motor 24 in the front of the left base link track 106 drives link 16. The controller 130 in base link 104 controls each driver connected to each motor 24 and 88. Similarly, the controller 148 in base link 106 controls each driver connected to each motor 134 which drive base link 12. The controller inside link 16 (FIG. 23(c)) controls the drivers that drive the motors related to the gripper mechanism 122.

The major advantages of the XBee OEM RF modules 142, 144 and 146 are: (i) it is available with a PCB chip antenna (FIG. 25), which eliminates the need for a vertically sticking out antenna for each link segment of the robotic platform; (ii) its operating frequency is 2.4 GHz—namely, different operating frequency than the primary 9Xtend/9Xcite RF module; (iii) fast RF data rate of 250 kbps; and (iv) its small form factor (2.5 times 3 cm) saved valuable board space in the compact design of the robot.

The chip antenna is suited for any application, but is especially useful in embedded applications. Since the radios do not have any issue radiating through plastic cases or housings, the antennas can be completely enclosed in our application. The XBee RF module with a chip antenna has an indoor wireless link performance of up to 24 m range. In the case of the hybrid robot design, the maximum fixed distance between the base link tracks and link 3 is less than 0.5 m.

This concept provides a simple and inexpensive solution when onboard inter-segmental wireless communication is required to avoid any wire and slip-ring mechanical connections between different parts of a given mechanical system.

To achieve longer-range transmission of the wireless data, an actuated antenna mechanism 185 is implemented on link 12 right. This mechanism consists of one rotational DOF actuated by a miniature servo motor. The command to this motor is dictated by the inclination of link 12 as provided by an inertial measurement unit (IMU) located in link 12. When the robot is flipped, the antenna is actuated 180° instantaneously in order to flip the orientation and maintain transmissibility of data with the operator's control unit. An additional antenna 192 located on the LIDAR mechanism 162 in link 16 can be used for wireless data communication with the OCU.

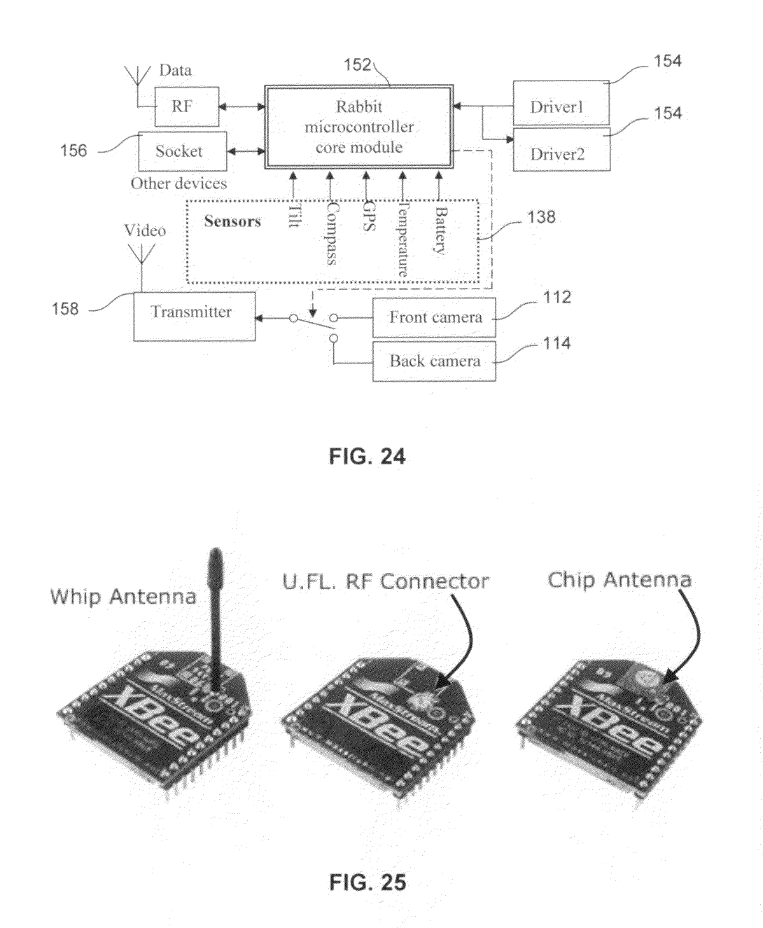

In another aspect of the invention an internal wireless communication system on-board mobile robots is depicted in FIG. 23, FIG. 24 and FIG. 37. A plurality of wireless data transmission systems 152, 142, 144, 146 having a plurality of sensors 138, 140, connected to a plurality of transceivers 142, 144, 146, 152 are located in at least one of the mechanical subsystems such as links, end effector, gripper mechanism which interface with other mechanical subsystems. An embodiment of the mechanical subsystems are indicated in FIG. 23(a), FIG. 23(b), FIG. 23(c) namely right base link track, left base link track, gripper mechanism. A plurality of data processing systems 130, 148, 150 having a plurality of processing units or controllers are located in some or all of the robotic mechanical subsystems as indicated in FIG. 23(a), FIG. 23(b), FIG. 23(c) such as links, end effector, gripper mechanism which are connected to transceivers 142, 144, 146, 152. There is internal wireless exchange of data between the data transmission systems 152, 142, 144, 146 and data processing systems 130, 148, 150 which enables the mechanical subsystems like right base link, left base link, second link, end link, gripper mechanism which interface with other mechanical subsystems to have unrestricted freedom of motion and help exchange the relative and absolute spatial positions and other relevant data.

In yet another aspect of the invention an internal wireless communication system includes a central wireless communication module system for communication with an operator control unit.

Referring to FIG. 24, preferably the controller 130 in each link is a Rabbit based core module 152. There are several analog input channels on the module through which the microcontroller receives signals from the sensors. Each motor in the base link tracks is driven by a motor driver 154, which acts as a motor controller to provide position and speed control. Signals from encoders attached to the rear shaft of each motor are sent to the drivers as feedback. A socket 156 to the microcontroller is reserved for other signals, which may be added in the future. As shown in FIGS. 24 and 31, there are two cameras 112, 114 located in the front and back of the left base link track, which provide visual information to the OCU operator on the robot's surroundings. A video transmitter 158 is used to transmit the video signals to the OCU 105. A switch controlled by the microcontroller 152. Note, this microcontroller 152 is stand alone, and can be connected to any of the controllers that exist in the left or right track decides the image of which camera is being transmitted. In addition audio signals may also be transmitted to the OCU 105.

Power is generally one of the constraining factors for small robot design. In order to generate the required torques for each link including the gripper mechanism, preferably rechargeable Lithium-Ion battery units in a special construction with the inclusion of Protection Circuit Modules (PCMs) are used in order to safely generate high current discharge based on the motors demands. With the combination of this power source along with a proper selection of brushless DC motors and harmonic gear-head drives, high torques can be generated. Each of the left 106 and right 104 base link tracks and the gripper mechanism situated in the space provided in third link 16 has a standalone power source.

It will be appreciated by those skilled in the art that the embodiments shown herein are by way of example and a number of variations or modification could be made to the embodiment whilst staying within the invention. For example, each miter gear 40 and 98 could be replaced with a bevel gear to allow any ratio greater than 1:1 to generate any desired torque to drive link 14 or link 16. For the same purpose, various diameter combinations for sprocket gears 46 and 100 can be selected to provide any desired torque value to drive pulley 26 and links 14 or 16. The front driving mechanism 70 and the back driving mechanism 90 can be reconfigured with different gear constructions and ratios to generate torque for driving the pulley 26 and links 14 or 16. For instance, the back driving mechanism can be changed such that the miter gear 40 and 98 and the sprocket gears 46 and 100 can be replaced altogether with one bevel gear set such that the driving bevel gear is attached to the motor 88 output shaft and the driven bevel gear is attached directly on the pulley 26. The motors 24 and 88 also can be reoriented differently inside the base links 12 to allow different gear constructions of driving mechanisms 70 and 90. Additional gear head types such as harmonic drives and planetary gears can be placed between driving mechanisms 70 and 90 and motors 24 and 88 respectively to generate any desired torque to drive link 14 or link 16. As well, the thrust bearing 56 is optional in the design. Further it will be appreciated that the robot may include more than three links. Rather the robot may include multiple links forming a snake-like robot.

Referring to FIG. 26, the hybrid mobile robot of the present invention may have wheels 160, rather than tracks 20. Wheels 160 are attached to base links 12. Base links 12, second link 14 and third link 16 are as described above. An end effector 122 is pivotally connected to third link 16. In the stowed or closed configuration shown in FIG. 26(d) end effector is nested in link 16 such that no part of end effector 122 is above or below link 16. Similarly link 16 is nested in link 14 and link 14 is nested between base links 12.

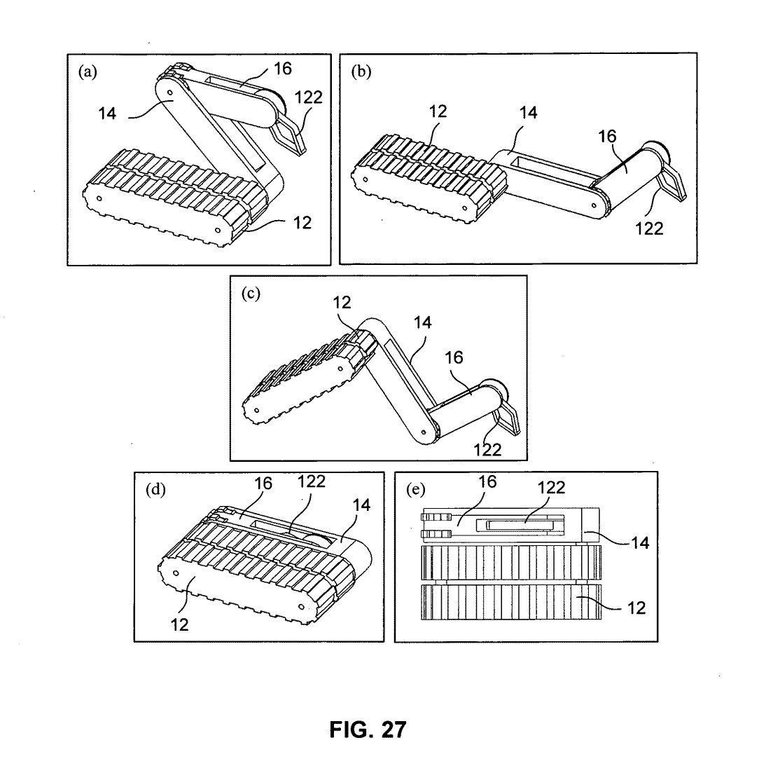

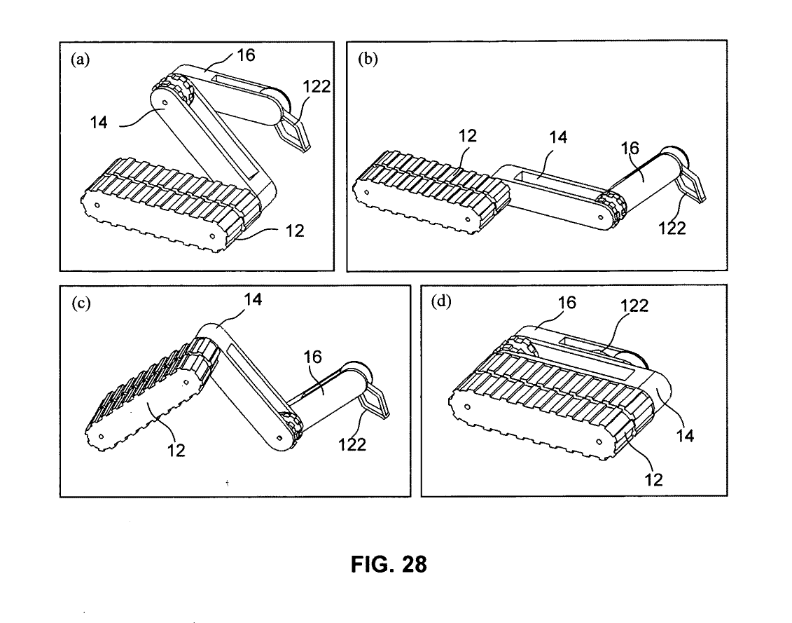

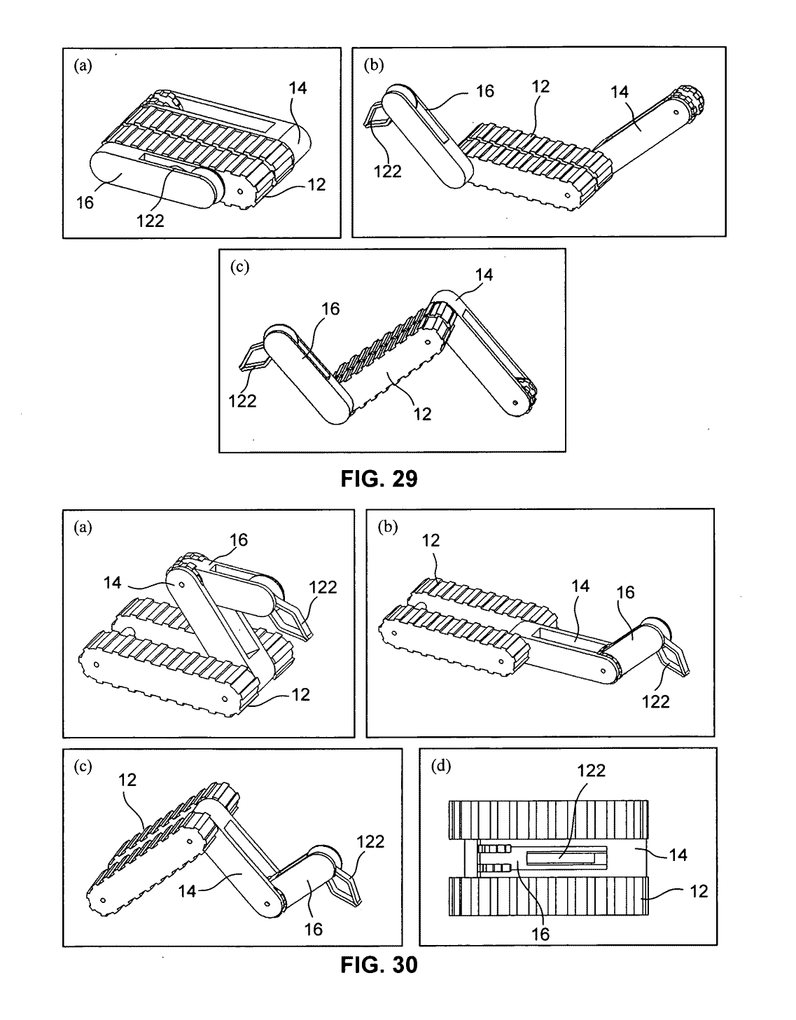

Referring to FIGS. 27 to 29, the positioning of the base links 12, the second link 14 and third link 16 may vary depending on the particular configuration. For example right and left base links 12 of the hybrid mobile robot of the present invention can be aligned proximate to each other, and joined at the front and the back, rather than spaced apart from each other. It will be appreciated by those skilled in the art that rather the two base links shown herein could be combined as a single base link. In these alternative embodiments, the second link 14 may fold by the side of the base links 12 and the third link 16 nests inside the second link 14 as shown in FIG. 27. Alternatively the third link 16 may fold by the side of the second link 14 as shown in FIG. 28. In a further alternative the second link 14 may be attached to one of the right and left base links 12, while the third link 16 is attached to the other of base links as shown in FIG. 29.

The embodiment shown in FIG. 29 also provides an additional or alternative location for an end effector. For example, since the third link 16 is attached to one of the base links 12, rather than to or inside the second link 14, a space is available for the second link 14 to have an additional end effector at its end (not shown). Furthermore, an additional link 16 with an end effector 122 can be attached to one of the base links. In one possible embodiment, one link 16 with end effector 122 can be attached to one end of one of the base links 12, while an additional link 16 with end effector 122 is nested inside link 14 that is attached to the other end of the other base link, which will increase the available locations for end effectors (not shown).

Referring to FIG. 30, the hybrid mobile robot of the present invention may be configured wherein the pair or first and second base links 12 are attached at the front and back and the second link is shorter than the base links and consequently the third link is shorter and in the previous embodiments.

Passive wheels 120 can be added on third joint 25 (shown in FIG. 31) between the gripper mechanism that occupies the space in link 16 and link 16. The passive wheels are used to create rolling friction and increase work efficiency of the platform when link 16 is used to support the entire platform for various mobility requirements. Passive wheels also reduce possible failure due to the arm/link wear-out. Referring to FIG. 31, a fully loaded robot is shown at 131. The fully loaded robot 130 includes an end effector 122 and different type of accessories that are usually imbedded in a mobile robot. Robot 130 has embedded flat data wireless antenna 108, embedded flat video wireless antenna 110, front and back CCD cameras 112, 114, front and back LED lights 116, 118. One antenna is used to transmit and receive traction and manipulation signals to the central control system and a second antenna is used to transmit and receive audio and video signals.

In another aspect of the present invention, the different links can be attached and detached to arrive at any of the various configurations according to the desired application.

It will be appreciate by those skilled in the art that in all of the embodiments shown herein the robot may flip over or be inverted. In order to facilitate this, the robot has a stowed position. The base links 12 define an upper plane and a lower plane, similarly the second link 14 defines a second link upper plane and lower plane; the third link 16 defines a third link upper plane and lower plane; and the end effector 122 defines an end effector upper and lower plane. In the stowed position the second link upper and lower plane, the third link upper and lower plane and the end effector upper and lower plane are all within the upper and lower plane of the base links. The embodiments shown in FIGS. 1 to 9, 26, 30 and 31 have a stowed position wherein the second link 14 is nested between spaced apart first and second base links 12, the third link 16 is nested in the second link 14.

It will be appreciated by those skilled in the art that the embodiments of the present invention provide solutions to a series of major issues related to the design and operation of mobile robots operating on rough terrain. Specifically the embodiments of the invention shown herein have major two advantages. The embodiments of the invention provide a novel approach for a mobile robot where the mobile platform and the manipulator arm are one entity rather than two separate and attached modules. In other words, the mobile platform is used as a manipulator arm and vice versa. This way, the same joints (motors) that provide the manipulator's dof's, also provide the mobile platform's dof's. As well the embodiments of the invention herein enhance the robot's mobility by “allowing” it to flip-over and continue to operate instead of trying to prevent the robot from flipping-over or attempting to return it (self-righteousness). When a flip-over takes place, the user only needs to command the robot to continue to its destination from the current position.

Each item of the idea has its own advantages, and each one is an idea by itself. Furthermore, the two parts of the idea complement each other.

In the embodiments of the present invention described herein, the mobile platform is part of the manipulator arm, and the arm is also part of the platform. As fewer components are required (approximately 50% reduction in the number of motors), the embodiments herein result in a much simpler and robust design, significant weight reduction and lower production cost. Another feature of the embodiments herein is that the arm and platform are designed as one entity, and the arm is part of the platform. This eliminates the exposure of the arm to the surroundings while the robot is heading to a target perhaps in close and narrow surroundings (e.g. an underground tunnel). As soon as the target is reached, the arm is deployed in order to execute desired tasks. Since the arm is part of the platform, it is not exposed to the surroundings, and the mobility is enhanced. In the embodiments herein the platform is symmetric and is therefore able to continue to the target from any orientation with no need of self-righting when it falls or flips over. This enhances considerably the ability of the robot to adapt to the terrain according to the needed degree of maneuverability and traction. Further when the robot encounters an obstacle or a steep inclination in the terrain it is sometimes inevitable and hence preferable to let the robot fall and roll, and continue its mission without self-righting in order to reach the target sooner.

A major advantage of the new design paradigm is that it is scalable. It can be applied to small backpack-able as well as large track-transported EOD (Explosive Ordnance Disposal) mobile robots.

In another aspect of the invention an autonomous hybrid mobile robot system is depicted in FIG. 33. The base link 12 has a drive system, a right base link and a left base link. Each of the right and left base links has a drive system. The right base link and the left base link are spaced apart. The base links are adapted to function as a traction device and a turret. A second link 14 attached to the base link 12 at a first joint 400. The second link 14 has a drive system and is adapted to function as a traction device and to be deployed for manipulation. An end link 16 attached to the second link 14 at a second joint 402, the end link 16 has a drive system. The end link 16 is adapted to function as a traction device and to be deployed for manipulation. A navigational system 162 housed inside the one of the links to automate obstacle traversal, obstacle avoidance and object manipulation with minimal or no operator input. The second link 14 could include multiple links and an end effector 122 attached the end link at a third joint 404. In another aspect of the invention as shown in FIG. 34 the second link 14 can also have a stowed position where the second link is nested between the left base link 12 and the right base links 12. In another aspect of the invention the end link 16 has a stowed position wherein the end link 16 is nested in the second link 14 and the end effector 122 has a stowed position wherein the end effector 122 is nested in the end link 16. In another aspect of the invention the first joint 400 is a revolute joint and the second link 14 is pivotal around 360 degrees continuously and the second joint 402 is a revolute joint and the end link 16 is pivotal around 360 degrees continuously and the third joint 404 is a revolute joint and the end effector is pivotal around 360 degrees continuously.

In yet another aspect of the invention wheels or a traction means 418 and 420 are attached to at least one of the second joint 402, the third joint 404, and each of the second joint 402 and third joint 404.

In yet another aspect of the invention the drive system is one of a pulley and track system having a front pulley, a back pulley and a track and a wheel drive system.

In yet another aspect of the invention as depicted in FIG. 35, the hybrid mobile robot has a half split centrally connected pulley drive mechanism for driving the tracks and actuated via a bevel gear assembly directly connected the motor and gear-box assembly.

In yet another aspect of the invention as depicted in FIGS. 35 and 36, a plurality of rotating antenna mechanisms 185, 192 for data communication that positions the antenna to the highest elevation with respect to the ground based on the position of the robot are located in different mechanical subsystems, such as the left or right base links 12, the navigation system 162, and end link 16.

In yet another aspect of the invention as shown in FIG. 24 the mechanical subsystems contain at least one of a plurality of inertial measurement units, GPS sensors, sonar sensors, cameras, illumination systems, and absolute encoders to monitor the angular rotation of base links, second link, end link, and end effector degrees of freedom.

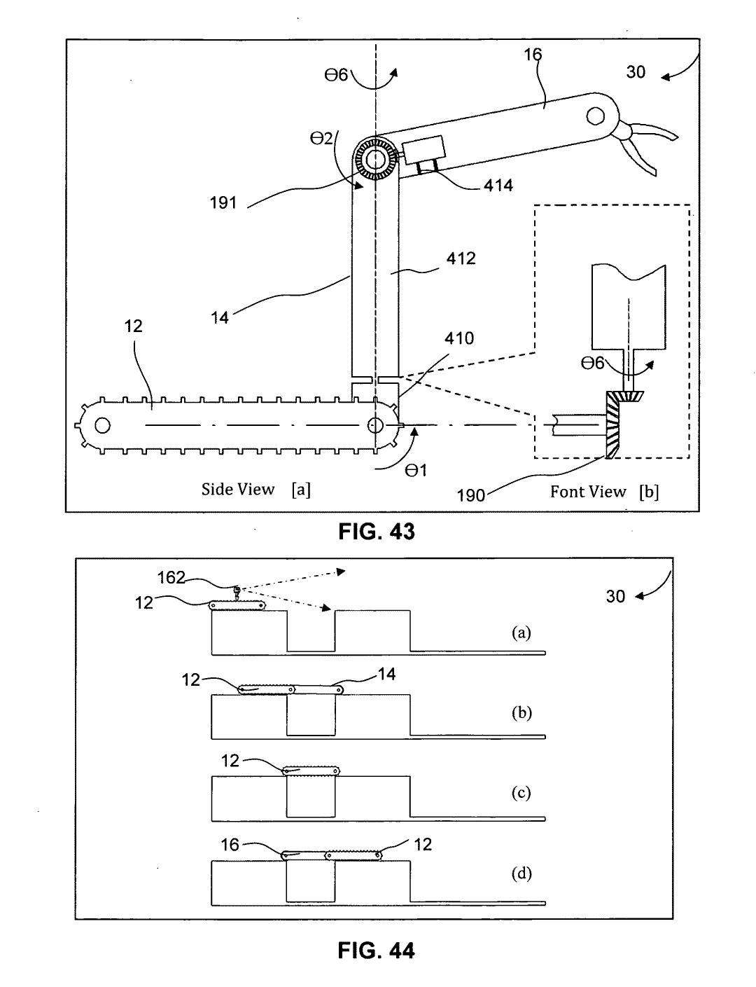

In another aspect of the invention as shown in FIG. 43, a hybrid mobile robot has a base link 12 that has a drive system. The base link 12 includes a right base link and a left base link and each of the right and left base links have a drive system, and the right base link and the left base link are spaced apart. The base link 12 is adapted to function as a traction device and a turret. A second link 14 has a first end 410 and a second end 412 capable of continuous rotation relative to each other about the longitudinal axis θ6 of the second link 14. The first end 410 of the second link 14 attached to the base link 12 at a first joint θ1, the second link 14 is adapted to function as a traction device and to be deployed for manipulation. An end link 16 attached to the second end 412 of the second link 14 at a second joint, the end link 16 having a self contained drive system 414 for the second joint 14 and being adapted to function as a traction device and to be deployed for manipulation. The continuous rotation of the second end 412 of the second link 14 is driven by a first drive mechanism located in the base link 12. The first joint θ1 is driven by a second drive mechanism located in the base link 12.

In another aspect of the invention as depicted in FIGS. 38, 39, 40 and 41, the end effector 122 is a self-contained structured of the robot. It consists of a fingers platform 424 that can accommodate at least three fingers 171, driven by a motor and gearbox assembly 426 housed inside the wrist. The motor output torque is amplified via a two-stage amplification mechanism comprising a gearbox and a worm and worm gear assembly 172. The worm provides in addition to torque amplification, braking means allowing the fingers to mechanically lock to their last position when the driving motor is not actuated. Position tracking of the fingers position is achieved via an absolute encoder 181 coupled directly to one of the fingers 171, although additional encoders can be also added to other fingers. This encoder is preferably powered by a 9V battery 174 located on the fingers platform 424 and providing power to the RF wireless module 182 and the wireless camera 173 in addition to the encoder 181. The wireless camera 173 is housed inside a custom-made compartment 428 and connected to the fingers platform. The camera possesses in this location an optimal field of view to record the process of gripping by the fingers and relay the visual data to the remote operator. The camera compartment 428 ensures that the load handled by the fingers does not cause any damage to the lens or the electronic board soldered directly to the back of the camera.

The RF-module 182 transmits readings from the encoder 181 to the gripper processing unit 179 or alternatively to the printed circuit board (PCB) located directly on top of the PC-104 single board computer 183 as shown in FIG. 38 over a wireless network; therefore discarding the need for any wired connections between the fingers and the wrist of the end effector 122 and enabling the robot's fingers platform 424 and wrist 422 to achieve endless rotation around the centroidal axis θ5. The wrist 422 is further actuated by a motor assembly 175 preferably including a brushless DC motor coupled to a gearbox and a worm and worm gear assembly. Housed inside the wrist is an absolute encoder not shown in a figure that provides an angular reading of the wrist's rotation along the full range of 0-360 degrees. This encoder is coupled to the axis of rotation θ5 through preferably a spur gear assembly. The motor controller 178 for this degree of freedom is housed inside the structure, while the controller 177 for the fingers' motor is preferably located at the back of the end effector. These two controllers 177 and 178 receive angular readings from the absolute encoders that monitor both joints θ4 and θ5 and are capable of providing position control as well as velocity control. The motors for actuating degrees of freedom θ4 and θ5 and the two controllers are powered by an assembly of preferably lithium-ion batteries 180 housed inside a sheet metal on top of the end effector. These batteries equally provide power to the end effector processing unit 179 and the encoders that monitor the position of θ3 and θ4 degrees of freedom.

Referring to FIGS. 39 and 42, the third degree of freedom θ3 providing the endless rotation of the end effector around itself is actuated by a motor-gearbox assembly similar to the one operating the fingers and which was described earlier in that context. A worm and worm gear assembly 187 is also adopted in this case to provide torque amplification in addition means of static braking. The rotation of this DOF is monitored by an absolute encoder housed inside the structure of the end effector and powered directly by preferably lithium—ion batteries 180. The rotation of θ3 is endless in the sense that the end effector can achieve a continuous 360° rotation around joint θ3 allowing its deployment and consequently the manipulation of objects from either side of the end link 16. In order to fold the end effector 122 inside the end link 16, fingers 171 must be first closed in order to avoid any clashing with the rest of the hardware located inside link 16.

In addition to the internal wireless communication between the electronic hardware of the end effector 122 as achieved via the RF-modules 182 and preferably the X-bee wireless transceiver module located on board 179, the end effector can receive autonomous commands from the single board computer 183 or directly from the operator's control unit (OCU). However, the latter can only be achieved at close proximity because the transmission of data is achieved via X-Bee wireless modules with limited range (reference to FIG. 37). Longer range data transmission can be achieved via preferably X-TEND wireless module located on the PCB-board of link 16. The X-TEND wireless module in link 16 communicates directly with another X-TEND wireless module located in the OCU. Data received by the X-TEND in link 16 is relayed through wire connection to another X-Bee wireless module sharing the same PCB board with the X-TEND. This X-Bee wireless module then communicates data to the end effector processing unit 179 (to the X-Bee located on the PCB board of link 16), and to left and right base links 12.

With this structure and layout, the end effector 122 is capable of handling objects up to 50 kg in weight. The weight of the end effector is calculated at 2.1 Kg; therefore providing a payload to weight ratio of around 23.8, far above the ratio of most highly dexterous end effectors, such as the Shadow arm with a payload-to-weight-ratio of 5. The self-containment aspect of the end effector further enhances the applicability aspect where no additional external hardware such as pressure valves and compressors are required. This feature greatly facilitates the implementation on different manipulators where minimal modifications to the arm structure are required.

In another aspect of the invention an end effector 122 for mobile robots consist of a self contained module as shown in FIGS. 38, 39, 40, and 41. The self contained module houses mechanical hardware including 171, 172, 175, 176, 177 and electrical hardware including 173, 174, 175, 177, 178, 179, 180, 181, 182 and 426. There is also a plurality of wireless communication modules 182 housed in the self contained end effector module for wireless communication with at least one of the robot's data processing units and operator's control unit. The self contained module is connected to the mobile robot end link 16 via a plurality of rotational pivots 404.

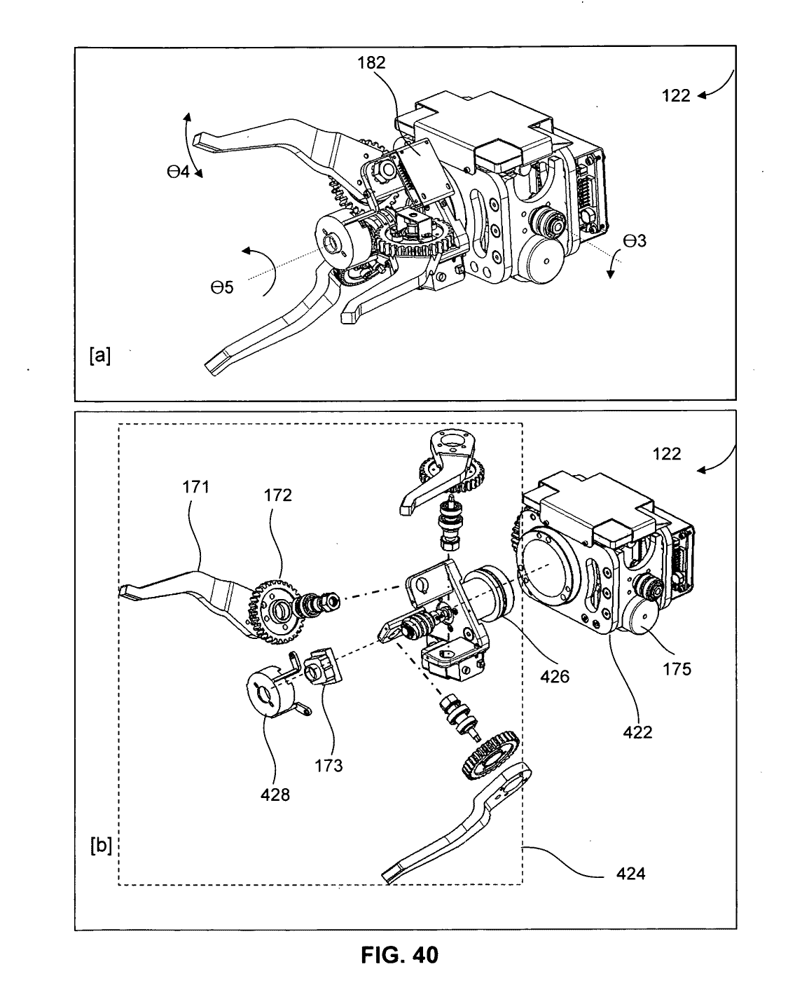

In another aspect of the invention, as shown in FIG. 40, the end effector 122 has a fingers platform 424 accommodating a plurality of fingers 171, a spur gear 172 attached to a proximal end of each of the plurality of fingers 171, the spur gear interfacing with a motor through a worm gear assembly enabling the plurality of fingers to move in a plane encompassing the worm gear longitudinal axis.

In another aspect of the invention the end effector 122 also has a wireless scheme at the fingers platform 424 signaling the fingers' spatial data wirelessly thereby enabling endless rotation of the fingers platform in a plane perpendicular to the plane of rotation of any one of the plurality of fingers.

In another aspect of the invention, as shown in FIG. 42, the end effector 122 further includes an additional motor-gearbox assembly (not shown in Figure) that enables endless rotation of the end effector 122 along the pivotal axis of the end effector assembly 122 and the end link 16 via a worm and worm gear assembly 187.

In another aspect of the invention the end effector 122 has a robust compact structure that can provide a payload to weight ratio of around 25. The end effector 122 could have a plurality of detachable fingers on the fingers platform, the detachable fingers also being capable of individual finger actuation.

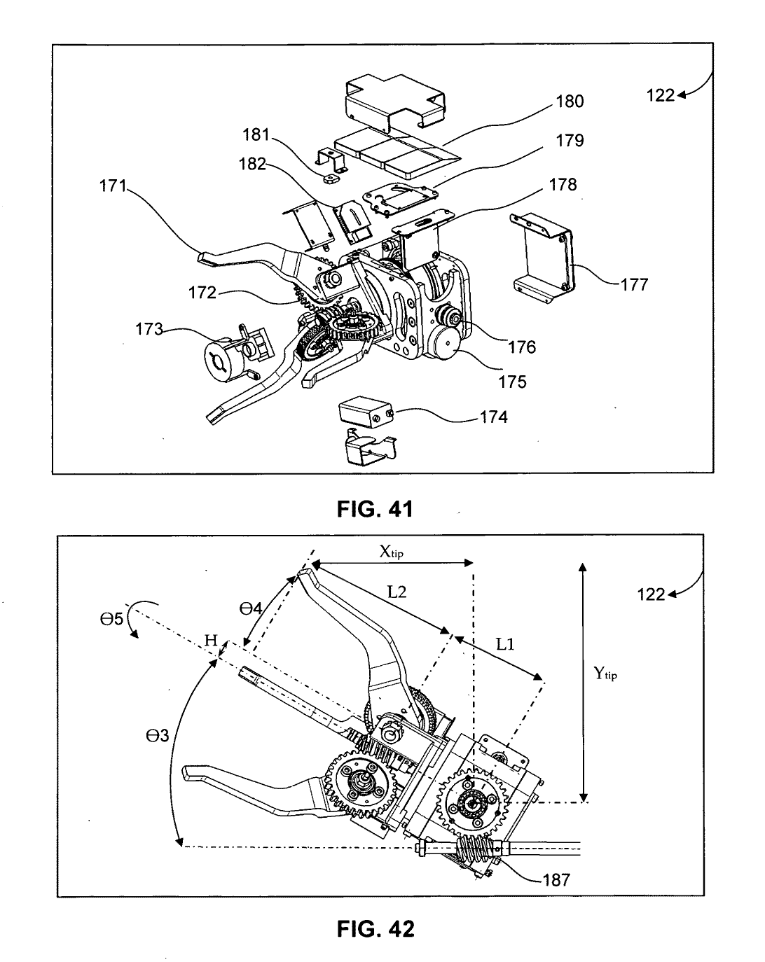

In another aspect of the invention as shown in FIG. 41, the end effector 122 has absolute encoders to monitor rotational degrees of freedom along at least one of the plane of rotation of the finger platform, the plane of rotation of spur gear 172 at the proximal end of the fingers and the plane of rotation of the end effector 122 relative to the end link 16.

In another aspect of the invention the end effector 122 has at least one power source. The end effector 122 has a camera 173 attached in the middle of the finger platform.

The end effector 122 can be described kinematically using three DOF's mathematical representation of joints θ3, θ4 and θ5. With reference to FIG. 42, the fingertip of one finger 171 is chosen as a point of interest on the end effector. This has been chosen for convenience although any other point on the end effector could serve as a suitable candidate for this representation. Knowing the location of the fingertips allows deriving the location of any other point of interest on the end effector, such as the geometrical or the dynamic center of mass. The three-dimensional location of the finger tip with respect to the reference frame, chosen in this case as a rectangular coordinate system with origin on the axis of rotation of θ3, is represented by the three coordinates Xtip, Ytip and Ztip (FIG. 42). In order to develop this mathematical model, we define the distance between the vertical plane and the axis of rotation of angle θ4 as L₁. Likewise, we define the length of a finger from the joint to the tip by L₂ and the vertical component separating the axis of rotation of joint θ4 from the central axis by H as shown in FIG. 42.

Angle θ4 is measured with respect to a horizontal line running through the joint's axis of rotation. Clockwise rotation is considered negative, while counterclockwise rotation is positive. As such, angle θ4=0 degrees when the tip of the respective finger is aligned with this reference axis. Angle θ5 is measured with respect to the vertical axis while angle θ3 is measured with respect to the horizontal axis following the right hand rule for sign convention.

With these conventions established, the kinematic model of the end effector can be represented with the following non-linear kinematic equations:

Xₜᵢₚ=L₁ cos(θ₃)+L₂ cos(θ₁)cos(θ₃)−{H+L₂ sin(θ₁)} cos(θ₂)sin(θ₃)

Yₜᵢₚ=L₁ sin(θ₃)+L₂ cos(θ₁)sin(θ₃)+{H+L₂ sin(θ₁)} cos(θ₂)cos(θ₃)

Zₜᵢₚ=L₂ sin(θ₁)sin(θ₂)+H sin(θ₂)

### Sensor Platform

The robot described herein possesses the sensor platform that enables the establishment of autonomous capabilities such as autonomous handling or autonomous obstacle climbing. In this context, the robot described herein includes a LIDAR and stereo-camera mechanism 162 that provides navigational and visual perception data to the robot, as depicted in FIG. 36. The visual data is gathered through a customized configuration of two CCD cameras 168 (forming a stereo vision) with a variable baseline providing depth information on the environment. This information, sampled at a rate of preferably 5 frames per second, is used to build a local map of the robot's vicinity. The 2-D LIDAR 167 mounted on the same mechanism 162 scans over preferably 240 degrees angle in the horizontal plane at an average scan time of preferably 28 msec/scan.

In order to build a local 3-D map of the environment around the robot, the LIDAR mechanism is equipped with an additional degree of freedom actuated by a servo motor 169 that achieves rotation of the LIDAR sensor in a vertical plane over a vertical range of preferably 40-60 degrees angle (±20-30 degrees angle with respect to the horizontal plane). This rotation extrapolates the 2-D scanning information of the LIDAR into the 3-D domain allowing a more realistic perception of the surrounding environment. An additional servo motor 170 deploys the LIDAR and stereo camera mechanism outside the link by rotating the whole assembly around the base pivot point.

Data processing is achieved on-board the robot via a single board computer 183 housed inside the end link 16. It will be appreciated in this content to note that the configuration of the LIADR and the stereo camera on the same mechanism, as well as the location of the single board computer are not compulsory; rather different embodiments can be achieved where for example, the LIDAR 167 can be placed in the end link 16 and the stereo cameras 168 in the base link 12 along with the single board computer 183. This enables further versatility of implementation and stands for the hybrid aspect of the robot herein.

In addition to the visual perception and navigational mechanism 162, the robot described herein includes an array of inertial and dynamic sensors. This includes an inertial measurement unit in the base link 12 providing the following inertial data: roll, pitch and yaw angles with respect to the gravitational line as well as dynamic acceleration components of the robot in a three-dimensional coordinate system. In addition, a GPS unit on the base link 12 provides the longitude and latitude location of the robot with respect to a global reference. Sonars 188 and 189 around the chassis of the base link 12 and in the front and back of link 12 provide proximity data about the location of the obstacles within the vicinity of the robot environment. All this sensor information can be used to achieve autonomy of the robot with respect to different aspects of operation, such as autonomous manipulation and autonomous climbing using the hybrid locomotion and manipulation capabilities of the structure.

In another aspect of the invention, as shown in FIG. 36, a navigational system for mobile robots consists of a LIDAR scanning sensor 167, a stereo camera assembly 168, a housing mechanism 430 which houses the LIDAR 167 and the stereo camera assembly 168 inside at least one of the robot links. The stereo camera assembly 168 provides depth perception and the LIDAR scanning sensor 167 augments the visual perception.

In yet another aspect of the invention the housing mechanism 430 has a 2-DOF mechanism operated by two servo motors, one located at a first end 170 of the housing mechanism 430 which lifts the whole housing mechanism outside the link housing the mechanism and the other located at a second end 169 which rotates the LIDAR 167 for the vertical scanning process.

In yet another aspect of the invention the entire housing mechanism 430 can be retracted without any protrusions into the link housing the navigational system. In another aspect of the invention the housing mechanism may be deployed from either side of the link housing the navigational system.

In yet another aspect of the invention a single board computer housed inside the link housing the navigational system 162 to process the data from the LIDAR scanning sensor 167 and the stereo camera system 168 are used.

In yet another aspect of the invention there is an option to separate the stereo camera 168 from the LIDAR 167 and placing them in other links with additional single board computers to process the data provided by the LIDAR separately from the data provided by the stereo camera. Antenna modules, transceivers, and processing units can be located in various mechanical subsystems in the robot, such as the navigational system, and other links of the robot.

### Modes of Operation:

In one of the modes of operation as illustrated in reference to FIG. 44 with a ditch crossing scenario: The hybrid mobile robot deploys its navigational system 162 to scan the environment and gather information on the ditch length. Accordingly, the following steps are executed either autonomously using the on-board computer or manually using command signals from the remote operator control unit:
The hybrid mobile robot approaches the ditch and opens link 14 to reach the other end of the ditch.
The hybrid mobile robot crosses the ditch using base links 12 for propulsion and link 14 to maintain stability and contact with the end side of the ditch.
The hybrid mobile robot is standing on top of the ditch through link 12 and deploys link 16 to the rear side of the movement in order to maintain balance and stability with the back side of the ditch. The hybrid mobile robot can then bring link 16 back inside link 14 once link 12 is supported enough by the end side of the ditch to prevent the tipping of the robot when link 16 looses contact with the ground.

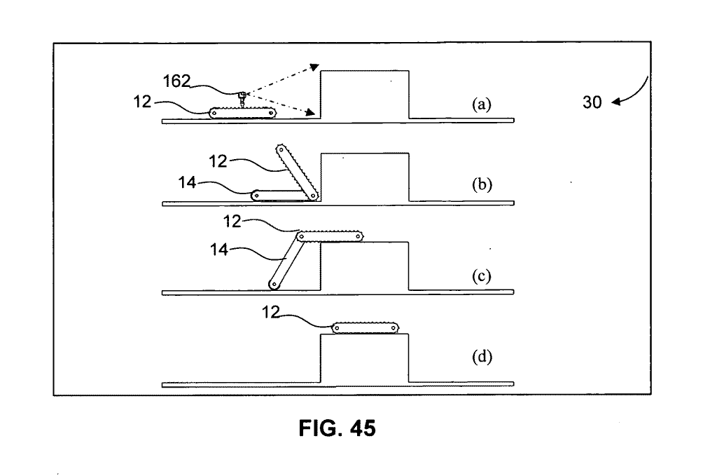

In a further mode of operation as illustrated in FIG. 45 with an obstacle climbing scenario: The hybrid mobile robot deploys its navigational system 162 to scan the environment and gather information on the height of the obstacle and the distance to the robot front. Accordingly, the following steps are executed either autonomously using the on-board computer or manually using command signals from the remote operator control unit:
The hybrid mobile robot deploys link 14 on the ground and lifts link 12 by actuating the pivot that drives angle θ1. The rotation continues until link 12 contacts the obstacle. The actuation is further continued until link 12 has rotated for 180 degrees angle allowing it to rest on the top side of the obstacle. Balance is maintained via the passive wheel of link 14 which maintains contact with the ground.
Link 12 is actuated to move further over the top face of the obstacle. Link 14 can be lifted back to fold inside link 12 only when the location of the COG of link 12 is further enough on the top side of the obstacle to prevent tipping of the robot.

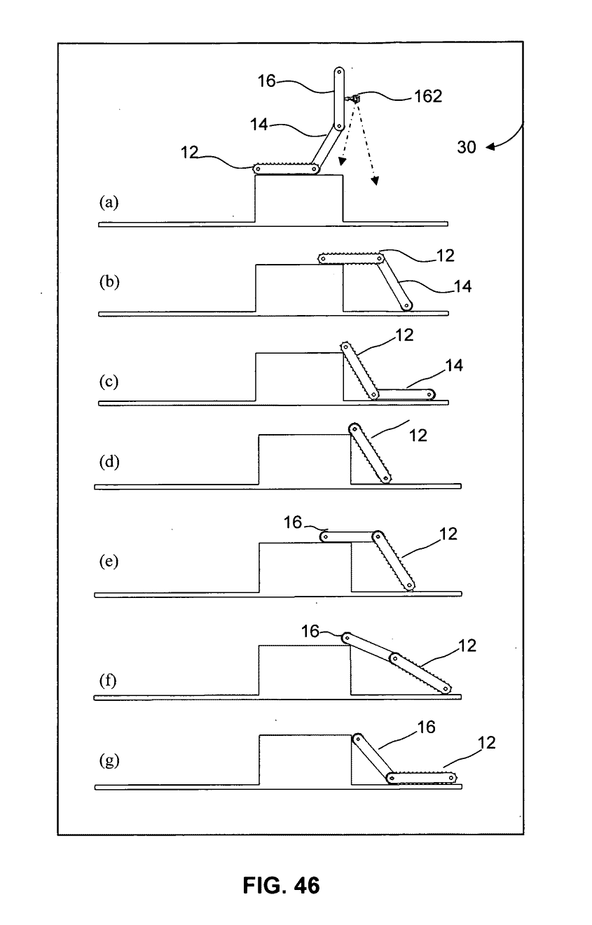

In a further mode of operation as illustrated in FIG. 46, with an obstacle descending scenario: The hybrid mobile robot deploys its navigational system 162 to scan the environment and gather information on the depth of the descent. This can be further enhanced using the manipulator arm and link 14 and 16 to extend the field of view of the navigational system 162. Accordingly, the following steps are executed either autonomously using the on-board computer or manually using command signals from the remote operator control unit:
The navigational system is folded inside link 16, and link 14 is deployed downwards until the passive wheel hits the ground. The wheel rolls on the ground as link 12 is actuated to move the robot forward. Therefore, link 14 in this case will maintain balance of the robot as the COG is moving away from the obstacle edge.
Angle θ1 is actuated to rotate link 14 back inside link 12. This will allow link 12 to move closer to the ground until the base links 12 tracks are in contact with the ground. Link 14 is then folded back into base links 12 and link 16 is deployed from the back to provide support to the back end of the base links 12 on the edge of the obstacle.
Link 12 is actuated to move further away from the obstacle while link 16 provides support from the back to prevent the robot from falling.
Link 16 will then rotate until the base links 12 become in contact with the ground to complete the descent process.

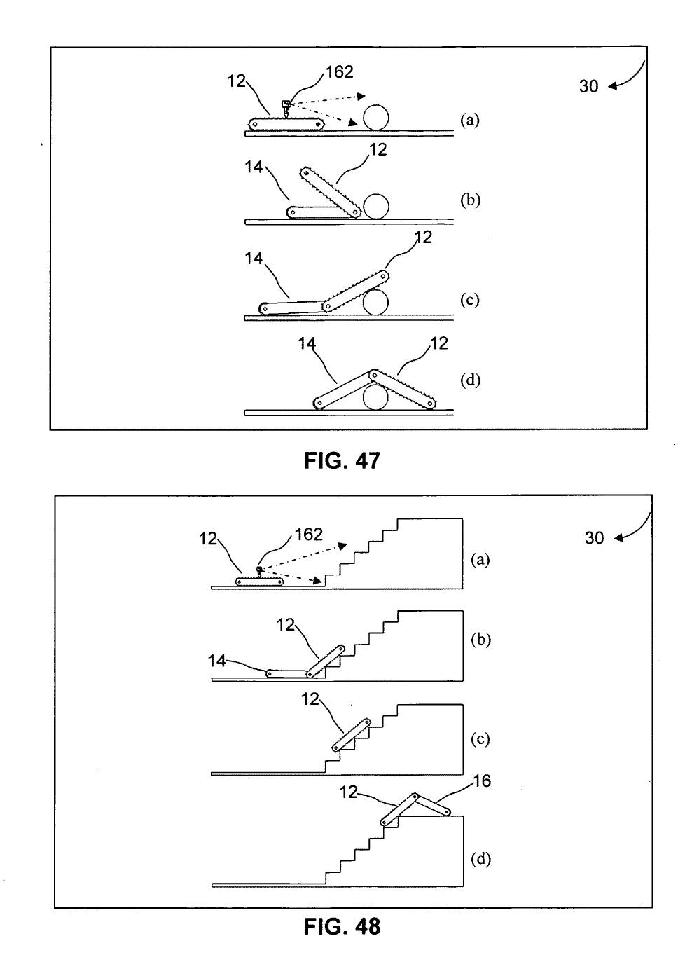

In a further mode of operation as illustrated in FIG. 47, with a cylindrical obstacle overcoming scenario: The hybrid mobile robot deploys its navigational system 162 to scan the environment and gather information on the height of the cylindrical obstacle. Accordingly, the following steps are executed either autonomously using the on-board computer or manually using command signals from the remote operator control unit:
The navigational system is folded inside link 16 and the joint θ1 is actuated to rotate link 12 until link 12 gets in contact with the obstacle, while link 14 maintains contact and balance with the ground via the passive wheel.
Once contact with the obstacle is established, link 12 tracks are actuated to traverse over the obstacle while link 14 continues to rotate and maintains contact with the ground via the rolling passive wheel, providing balance and preventing link 12 from falling backwards.
Link 12 tracks continue to propel the robot until the center of gravity of the robot crosses the centerline of the obstacle. This enables link 12 to traverse over the obstacle and achieve contact with the ground on the other side of the obstacle. Link 12 continues the descending movement until link 14 is lifted above the ground and back inside link 12.

In a further mode of operation as illustrated in FIG. 48, with a stairway climbing obstacle: The hybrid mobile robot deploys its navigational system 162 to scan the environment and gather information on the height of the first step and the outline of the stairway. Accordingly, the following steps are executed either autonomously using the on-board computer or manually using command signals from the remote operator control unit:
The navigational system is folded inside link 16 and link 12 is rotated by actuating joint θ1 with link 14 providing balance and thrust on the ground until link 12 contacts the stairs.
When link 12 touches the stairs, the actuation of joint θ1 is reversed to rotate link 14 back inside link 12. Alternatively, link 14 can remain deployed 180 degrees angle relative to link 12 to provide support to link 12 from the back and preventing it from tipping over on the stairs. Link 12 tracks are actuated to move up the stairs using the tracks.
Once the robot reaches the top of the stairs, link 16 is deployed from the front until it smoothly contacts the top surface of the stairs via the passive wheel located in the third joint. This is achieved by actuating joint θ2 while at the same time maintaining propulsion using the tracks.

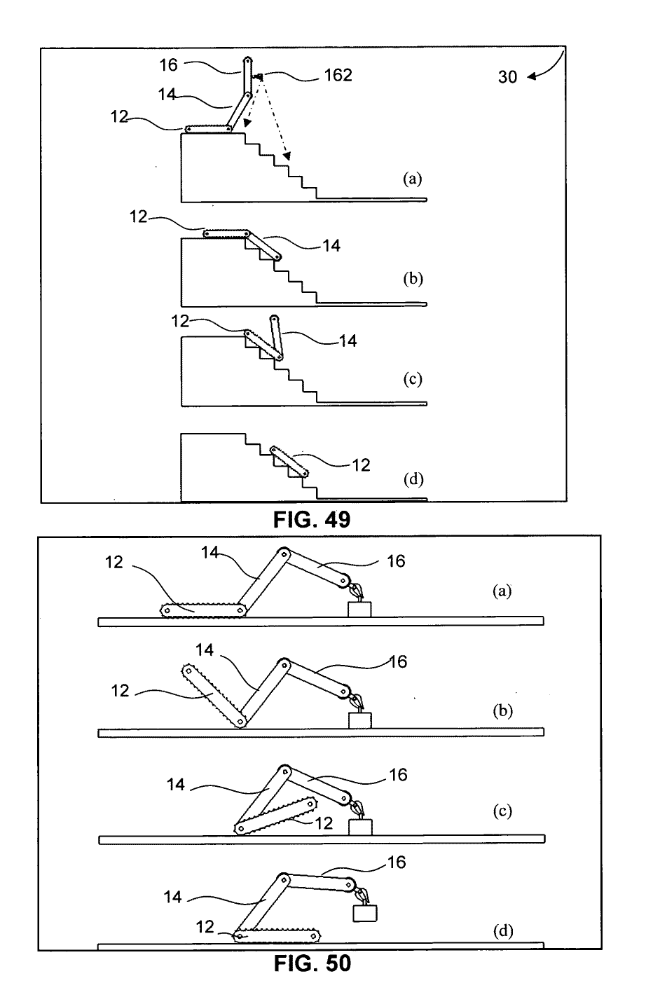

In a further mode of operation as illustrated in FIG. 49, with a stairs descending scenario: The hybrid mobile robot deploys its navigational system 162 to scan the environment and gather information on the depth of the descent and the steps height. This can be further enhanced using the manipulator arm and link 14 and 16 to extend the field of view of the navigational system 162. Accordingly, the following steps are executed either autonomously using the on-board computer or manually using command signals from the remote operator control unit:
Link 14 is deployed down to contact the steps allowing link 12 to thrust towards the steps until the center of gravity of link 12 crosses the step edge. Link 12 then rotates down towards the steps balanced by link 14 which maintains contact with the steps.
Once link 12 is in full contact on the steps, link 14 can be either rotated back inside link 12 or remain deployed 180 degrees angle relative to link 12 in order to provide support during descent and prevent flipping over of the robot on the stairs.
Link 12 continues the descent on the steps by propelling the tracks.

In a further mode of operation as illustrated in FIG. 50, with an adaptive manipulation scenario: The hybrid mobile robot extends its manipulator arm to grip an object with the end effector. However, if the load is eccentric, this will create an unbalanced configuration of the robot, and the following steps are consequently executed in the following concession:
Lifting an object with the end effector 122 using a configuration where link 14, and end link 16 are extended towards the object and the end effector 122 is used to lift the object in an off-centric location of loading resulting in shifting of the center of gravity towards the object being lifted.
Actuating the drive of the first joint to rotate link 14 in the counter clockwise direction resulting in eccentric loading and link 12 rotating around the first joint while maintaining an anchor point with the ground while link 12 reactively continues to rotate and reaches a stable configuration with the center of gravity of the robot realigning within link 12.
Lifting the load using the end effector 122 after link 12 realigns itself with the ground providing a stable configuration that enables the robot to lift heavy objects.
The described method provides mobile robots with a longer reach to manipulate objects and then automatically reconfiguring the robot structure to provide heavy load lifting capability.

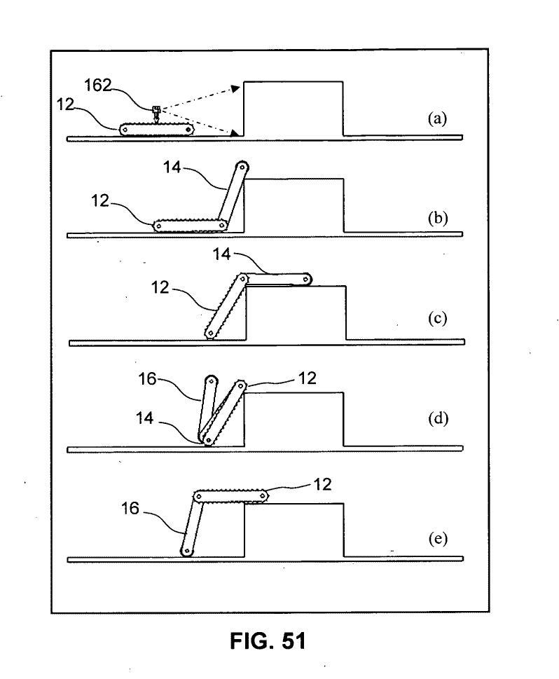

In a further mode of operation as depicted in FIG. 51, with a step climbing scenario using link 14 and link 16: The hybrid mobile robot deploys its navigational system 162 to scan the environment and gather information on the height of the obstacle and its outline. Accordingly, the following steps are executed either autonomously using the on-board computer or manually using command signals from the remote operator control unit:
Repositioning the base link 12 if necessary with the pivot connecting the joint θ1 facing toward the obstacle.
Approaching the basal edge of the obstacle if necessary using the base link 12 based on the navigational data.
Actuating the joint θ1 to rotate link 14 away from the ground until link 14 contacts the obstacle.
Rotating link 14 further and balancing via the base link which maintains contact with the ground until link 14 rotates enough to allow it to rest on top of the obstacle.
Traversing closer to the obstacle using the base link 12 tracks while the link 14 provides support on the top surface of the obstacle via the rolling passive wheel until the base link contacts with the obstacle.
Rotating link 14 into the base link 12 while balancing and maintaining ground contact through the base link 12.
Deploying the end link 16 outside the second link 14 and maintaining contact with the ground via the rolling passive wheel at the second joint.
Rotating the end link 16 while the second link 14 is stowed inside the base link 12 will lift the base link 12 until it aligns with the top surface of the obstacle.
Actuating the base link 12 tracks until the center of gravity of the robot is over the top edge of the obstacle.
Retracting the end link 16 inside the base link 12 once the base link 12 is adequately supported at the top of the obstacle to prevent tipping over of the robot when the end link loses contact with the ground.

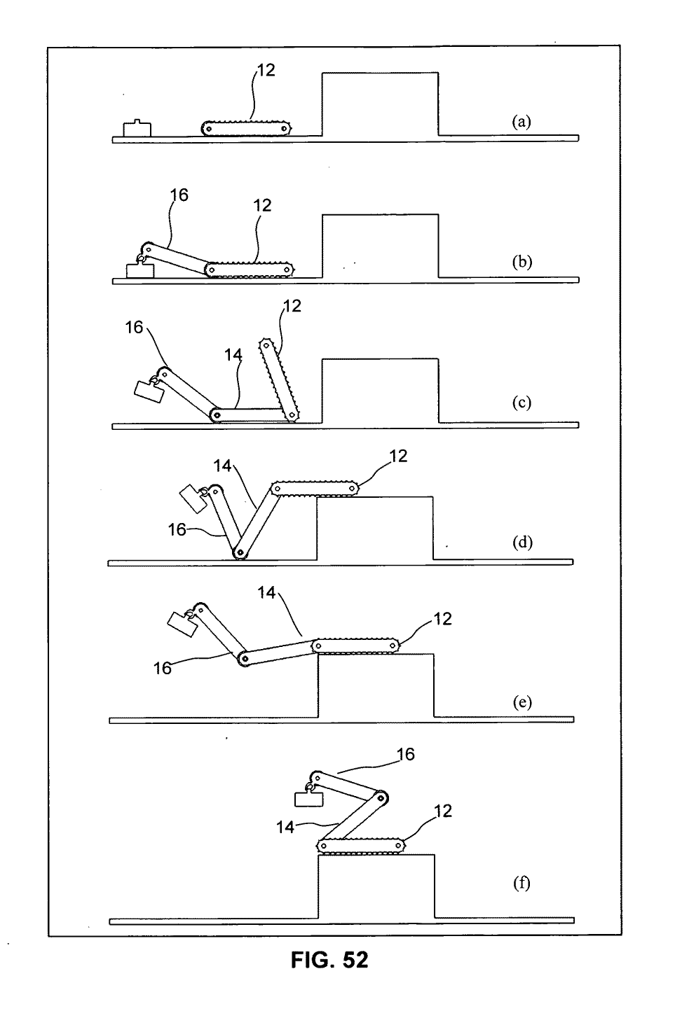

In a further mode of operation as depicted in FIG. 52, with a step ascending scenario using link 14 and link 16 with simultaneous object manipulation: The hybrid mobile robot deploys its navigational system 162 to scan the environment and gather information on the height of the obstacle. Accordingly, the following steps are executed either autonomously using the on-board computer or manually using command signals from the remote operator control unit:
Lifting an object using the end effector 122 and actuating the first joint which results in link 12 being rotated until link 12 contacts with the top surface of the step and rests on the top surface.
Link 12 tracks are actuated until the center of gravity of the robot moves over the top edge while maintaining balance with link 14 using passive wheels located in the second joint.
Actuating the first joint to rotate the link 14 and with it link 16 such that the object is lifted over the obstacle and repositioning links 14 and 16 to ensure the center of gravity of the robot falls within link 12.

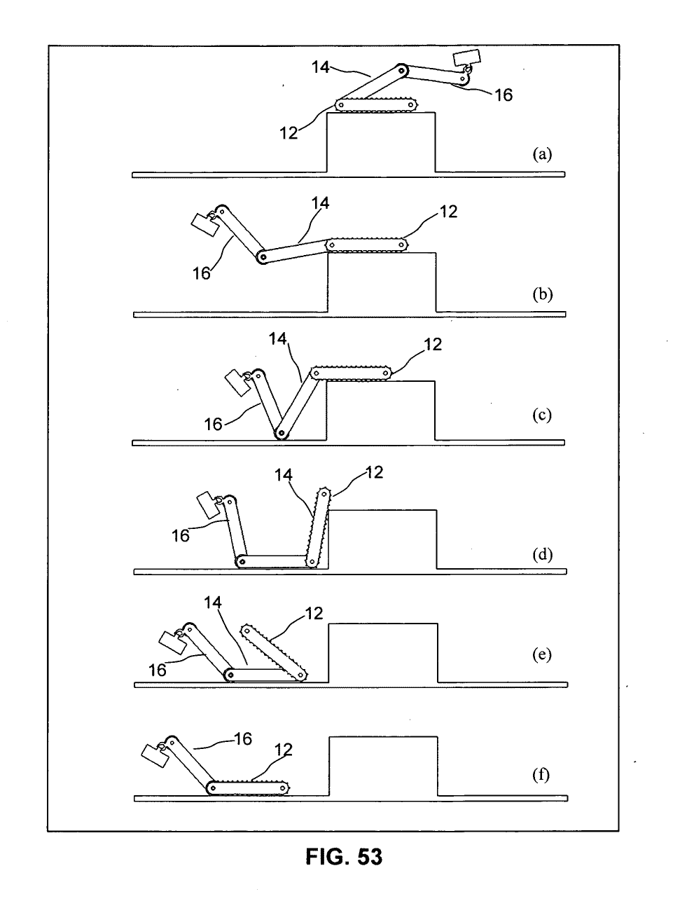

In a further mode of operation as depicted in FIG. 53, with a step descending scenario using link 14 and link 16 with simultaneous object manipulation: The hybrid mobile robot deploys its navigational system 162 to scan the environment and gather information on the depth of the obstacle descent. Accordingly, the following steps are executed either autonomously using the on-board computer or manually using command signals from the remote operator control unit:
An object is lifted using the end effector 122 while balancing the centre of gravity by repositioning the second link 14 and end link 16 to a stable position.
The base link 12 is repositioned towards the edge of the obstacle if required using navigational data from the navigation system and other sensors of the robot if required.
The first joint is actuated to rotate the second link 14 and the end link 16 over the edge of the obstacle and towards the support surface beyond the obstacle until the second joint touches the support surface via the wheel in the second joint.
The base link 12 is actuated forward using the tracks while the second joint maintains a rolling contact with the ground through the wheel in the second joint and ensures the centre of gravity of the robot prevents flipping over of the robot.
The first joint is actuated to move link 14 in the clockwise direction resulting in the link 12 moving in the counter clockwise direction until the link 12 rests on the top edge of the obstacle and the second link touches the support surface beyond the obstacle.
The first joint is actuated to continue rotating the base link 12 in a counter clockwise direction until the base link 12 returns the second link 14 to its stowed position and rests on the support surface while rebalancing the centre of gravity of the robot using the second joint if necessary.

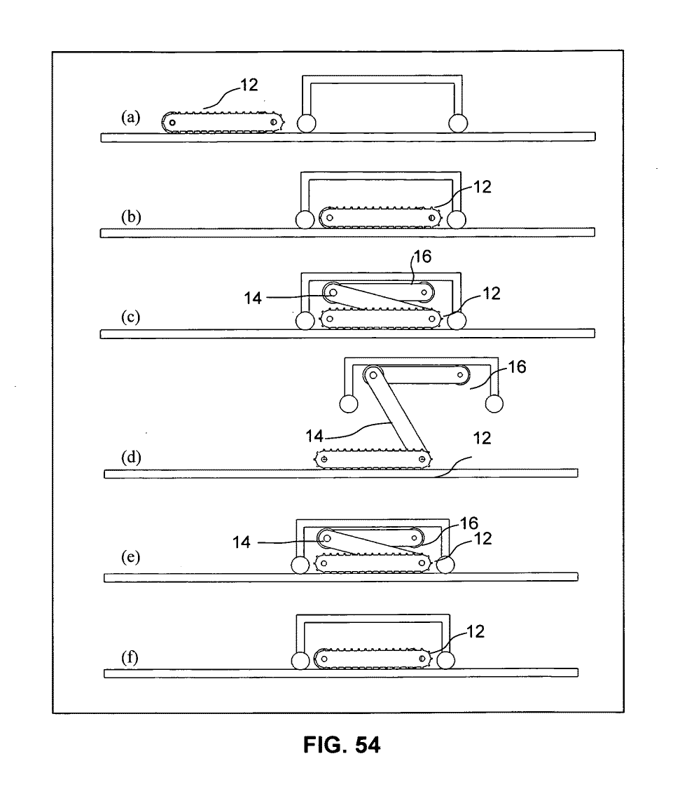

In a further mode of operation as illustrated in FIG. 54, manipulating an object: The hybrid mobile robot deploys its navigational system 162 to scan the environment and gather information. Accordingly, the following steps are executed either autonomously using the on-board computer or manually using command signals from the remote operator control unit:
The robot is positioned with the second link 14 and end link 16 stowed away within the base link 12 in between the object to be manipulated and a support surface.
The drives of the first joint and second joint are actuated to rotate the second link 14 in a first direction and the end link 16 in a second direction opposite to the first direction resulting in the end link 16 resting on the object to be manipulated.
The drives of the first and the second joint are actuated further resulting in the object being translated away from the base link 12.
The base link 12 is propelled if necessary to reposition the object in the desired location.
The drives of the first joint and the second joint are actuated in the reverse directions to the directions as carried out in the first step resulting in the second link 14 and end link 16 retracing into a stowed position within the base link 12.

Generally speaking, the systems described herein are directed to hybrid mobile robots. As required, embodiments of the present invention are disclosed herein. However, the disclosed embodiments are merely exemplary, and it should be understood that the invention may be embodied in many various and alternative forms. The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to hybrid mobile robots.

As used herein, the term “about”, when used in conjunction with ranges of dimensions, temperatures or other physical properties or characteristics is meant to cover slight variations that may exist in the upper and lower limits of the ranges of dimensions so as to not exclude embodiments where on average most of the dimensions are satisfied but where statistically dimensions may exist outside this region.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed as the invention is:

1. An autonomous hybrid mobile robot comprising:
a base link having a drive system, wherein the base link includes a right base link and a left base link, wherein each of the right and left base links have a drive system, and the right base link and the left base link are spaced apart, the base link adapted to function as a traction device and a turret;
a second link attached to the base link at a first joint, the second link having a drive system and being adapted to function as a traction device and to be deployed for manipulation;
an end link attached to the second link at a second joint, the end link having a drive system and an end effector attached to the end link at a third joint and the end link being adapted to function as a traction device and to be deployed for manipulation; and
a navigational system housed inside one of the links to automate obstacle traversal, obstacle avoidance and object manipulation with minimal or no operator input.

2. An autonomous hybrid mobile robot as claimed in claim 1 wherein the second link has a stowed position where the second link is nested between the left base link and the right base links and the end link has a stowed position wherein the end link is nested in the second link and the end effector has a stowed position wherein the end effector is nested in the end link.

3. An autonomous hybrid mobile robot as claimed in claim 1 wherein the first joint is a revolute joint and the second link is pivotal around 360 degrees continuously and the second joint is a revolute joint and the end link is pivotal around 360 degrees continuously and the third joint is a revolute joint and the end effector is pivotal around 360 degrees continuously.

4. An internal wireless communication system on-board mobile robots comprising:
a plurality of data transmission systems having a plurality of sensors connected to a plurality of transceivers, the data transmission systems are located in at least one of the mechanical subsystems which interface with other mechanical subsystems such as drive systems, links, end effector, fingers platform, and fingers; and
a plurality of data processing systems having a plurality of processing units connected to transceivers, the data processing systems are located in some or all of the mechanical subsystems such as drive systems, links, end effector, fingers, and fingers platform;
wherein the wireless exchange of data between the data transmission systems and data processing systems enables the mechanical subsystems which interface with other mechanical subsystems to have unrestricted freedom of motion and help exchange the relative and absolute spatial positions and other relevant data.

5. An internal wireless communication system as claimed in claim 4 wherein at least one of the data transmission systems is used for communication with an operator control unit.

6. An end effector for mobile robots comprising:
a self contained module, the self contained module housing mechanical and electrical hardware;
a plurality of wireless communication modules housed in the self contained module for internal wireless communication with at least one of the robot's data processing systems, and operator's control unit;
wherein the self contained module is connected to the mobile robot end link via a plurality of rotational pivots.

7. An end effector as claimed in claim 6 wherein the mechanical hardware of the self contained module includes a fingers platform capable of endless rotation around a first axis perpendicular to the plane of attachment of the fingers platform to the end effector using a drive mechanism.

8. An end effector as claimed in claim 7 wherein the end effector is capable of endless rotation around a second axis along the joint between the end effector and the link on which the end effector is attached.

9. An end effector as claimed in claim 8 further comprising a fingers platform having a plurality of fingers for actuating the fingers on a third axis along any plane perpendicular to the plane of attachment of the fingers platform to the end effector.

10. An end effector as claimed in claim 9 further comprising absolute encoders to monitor rotational degrees of freedom of the fingers along at least one of the first axis, the second axis and the third axis.

11. An end effector as claimed in claim 9 further comprising internal wireless communication systems for transmitting spatial data.

12. An end effector as claimed in claim 11 wherein at least one additional internal wireless communication system is located on the fingers.

13. An end effector as claimed in claim 6 further comprising at least one power source.

14. An end effector as claimed in claim 9 wherein the plurality of fingers are detachable fingers capable of individual finger actuation.

15. An end effector as claimed in claim 9 further comprising a camera attached to the fingers platform.

16. A navigational system for mobile robots comprising:
a LIDAR scanning sensor;
a stereo camera assembly;
a plurality of internal wireless communication units connected to the LIDAR scanning sensor and the stereo camera assembly; and
a housing mechanism which houses the LIDAR scanning sensor and the stereo camera assembly inside at least one of the robot links wherein the stereo camera assembly provides depth perception and the LIDAR scanning sensor augments the visual perception.

17. A navigational system as claimed in claim 16 wherein the housing mechanism has a two degree of freedom mechanism operated by two servo motors, one located at a first end of the housing mechanism which lifts the whole housing mechanism outside the link housing the mechanism and the other located at a second end which rotates the LIDAR scanning sensor for the vertical scanning process.

18. A navigational system as claimed in claim 16 wherein the entire housing mechanism can be retracted without any protrusions into the link housing the navigational system and may be deployed from either side of the link housing the navigational system.

19. A navigational system as claimed in claim 16 wherein the stereo camera assembly may be separated from the LIDAR scanning sensor and housed in other links with additional internal wireless communication units to process the data provided by the LIDAR scanning sensor separately from the data provided by the stereo camera assembly.

20. A hybrid mobile robot as claimed in claim 1 wherein the second link has a first end and a second end capable of continuous rotation relative to each other about the longitudinal axis of the second link, having the first end of the second link attached to the base link at a first joint, the second link being adapted to function as a traction device and to be deployed for manipulation, the end link attached to the second end of the second link at a second joint, the end link having a self contained drive system for the second joint and being adapted to function as a traction device and to be deployed for manipulation, the continuous rotation of the second end of the second link is driven by a drive mechanism located in the base link, and the navigation system is not present in the hybrid mobile robot.

21. An autonomous mobile robot as claimed in claim 1 further comprising at least one of a plurality of electronic subsystems such as, inertial measurement units, GPS sensors, sonar sensors, cameras, illuminations systems, and absolute encoders to monitor the angular rotation of base links, second link, end link, and end effector degrees of freedom, and provide situational data.

22. A method of operating a hybrid mobile robot which comprises:
a) Locomoting the position of the hybrid mobile robot using at least one of base link, second link, end link, end effector, and a combination of links for traction while the other links are positioned for maneuverability or for support;
b) Manipulating an external object using at least one of base link, second link, end link, end effector, and a combination of links while the other links are used to maintain stability;
c) Combining the locomotion and manipulation of steps a and b concurrently or in succession in various combinations to achieve at least one of locomotion of position, manipulation, and both locomotion and manipulation.

23. A method of operating the hybrid mobile robot as claimed in claim 22 wherein the locomoting of position is augmented by using at least one of passive wheels, and active wheels, to provide stability and support for links when used for locomotion.

24. A method of operating the hybrid mobile robot as claimed in claim 22 wherein the manipulating of the external object is augmented by using at least one of passive wheels, and active wheels, to provide stability and support for links when used for manipulation.
